(19) United States
(12) Patent Application Publication
(10) Pub. No.: US 2022/0340344 A1
(43) Pub. Date: Oct. 27, 2022

(54) ENCLOSED PACKAGING TRAY

(71) Applicant: PAC 360 Design, Inc., Memphis, TN (US)

(72) Inventors: Shea Oddo, Nesbit, MS (US); John McDonald, Hernando, MS (US)

(21) Appl. No.: 17/660,383

(22) Filed: Apr. 22, 2022

Related U.S. Application Data
(60) Provisional application No. 63/203,330, filed on Jul. 16, 2021.
(60) Provisional application No. 63/185,993, filed on May 7, 2021.
(60) Provisional application No. 63/178,357, filed on Apr. 22, 2021.

(51) Int. Cl. B65D 75/30

(52) U.S. Cl. CPC B65D 75/30

(57) ABSTRACT

A packaging assembly including a retention sheet formed of a resilient material and attached with foldable portions of a frame formed of a stiff material. The frame includes one or more wings and lateral portions that can be folded to enclose a packaged article between a platform on the frame and the retention sheet for shipping, storage or other uses.

### CROSS REFERENCE

Any and all applications for which a foreign or domestic priority claim is identified in the Application Data Sheet as filed with the present application are hereby incorporated by reference under 37 CFR 1.57.

### BACKGROUND

This disclosure generally relates to devices, systems, and methods for forming an enclosed packaging tray.

### SUMMARY

Forming an enclosed tray using a heat shrink tunnel according to a conventional method requires multiple steps, expensive machinery, and environmentally unfriendly heat-shrinkable film. Achieving the correct settings on the heat shrink tunnel (e.g., conveyer speed, temperature, etc.) requires trial and error leading to wasted materials. The heat-shrinking also hardens the heat-shrinkable film, resulting in packages that are brittle and non-recyclable. Accordingly, one aspect of the present disclosure is an enclosed tray that can retain the benefits of a heat-shrink package, without requiring heat-shrinkable film and/or heat shrink tunnel machinery.

Another aspect of the present disclosure is a packaging tray assembly formed of a sheet member or frame and a retention member. The frame can be rectangular or square. The frame can include first and second wing portions, a platform, and first and second lateral portions. The first and second wing portions can be formed by first and second fold lines. The first and second fold lines can be parallel to each other and separate the first and second wing portions from the central portion. The first and second lateral portions can be formed by third and fourth fold lines that separate the first and second lateral portions from the central portion. The first and second lateral portions can be between to the first and second wing portions. The first and second fold lines can be transverse or perpendicular to the third and fourth fold lines. The third and fourth fold lines can cross the first and second fold lines to form first, second, third, and fourth corner portions of the frame.

The retention member can include a first end that is attached with the first wing portion and first and second corner portions. The first end of the retention member can be wider than the platform and/or the first wing portion alone. The retention member can include a second end that attaches with the third corner, the fourth corner, and the second wing portion. The second end of the retention member can be wider than the platform and/or the second wing portion alone. A first lateral edge of the retention member can extend between the first and second end of the retention member on a first side. A second lateral edge of the retention member can extend between the first and second end of the retention member on a second side.

The frame can be first folded along the first fold line so that the first corner, the first wing portion, and the second corner are folded underneath the first lateral portion, the central portion, and the second lateral portions, respectively. The third corner, the second wing portion, and the fourth corner can be folded about the second fold line to be placed under the first lateral portion, the platform, and the second lateral portion. Folding on the first and second folds can stretch the retention member to retain any item placed between a central portion of the retention member and the platform. Next, the first and third corners and the first lateral portion can be folded upwardly along the third fold line to form a first folded wall. The first folded wall can be vertical (e.g., generally perpendicular with the platform). The first lateral edge of the retention member can be pulled and stretched upwardly over the first folded wall and outwardly to an exterior side of the first folded wall to enclose one end of the frame and the platform. The second lateral portion along with the second and fourth corners can be folded upwardly along the fourth fold line to form a second folded wall, opposite the first folded wall. The second folded wall can be vertical (e.g., generally perpendicular with the platform). The second lateral edge of the retention member can be pulled and stretched upwardly over the second folded wall and outwardly to an exterior side of a seconded folded wall. The stretching of the first and second lateral edges of the resilient member over the respective first and second folded walls can retain the folded walls in place (e.g., vertical) and they can allow the retention member to fully enclose an upper side of the platform to retain any items packaged on the platform. The enclosed tray can protect the packaged items from damage from drops, moisture, dust, etc.

The foregoing summary is illustrative only and is not intended to be limiting. Other aspects, features, and advantages of the systems, devices, and methods and/or other subject matter described in this application will become apparent in the teachings set forth below. The summary is provided to introduce a selection of some of the concepts of this disclosure. The summary is not intended to identify key or essential features of any subject matter described herein

### BRIEF DESCRIPTION OF THE DRAWINGS

FIG. 1 shows a plan view of a first packaging assembly;

FIG. 2 shows a photo of the packaging assembly;

FIG. 3 shows a photo of the packaging assembly with an article placed between a retention member and a platform of a frame of the packaging assembly;

FIG. 4 shows first and second wing portions folded underneath the platform to tensioned the retention member;

FIG. 5 shows a user inserting fingers underneath the first lateral edge of the retention member and folding up the first lateral portion to form the first folded wall;

FIG. 6 shows the first lateral edge of the retention member being stretched over the first folded wall;

FIG. 7 shows the first folded wall with the first lateral edge of the retention member folded over the first folded wall to an exterior side;

FIG. 8 shows stretching of the second lateral edge of the retention member over a second folded wall;

FIG. 9 shows stretching of the second lateral edge of the retention member over a second folded wall;

FIG. 10 shows stretching of the second lateral edge of the retention member over a second folded wall;

FIG. 11 shows the enclosed tray formed by the packaging assembly;

FIG. 12 shows the enclosed tray inserted within a box for shipment or transport;

FIG. 13 shows the addition of an adhesive strip on the first folded wall to attach with the first lateral edge of the retention member;

FIG. 14 shows the addition of an adhesive strip on the first folded wall to attach with the first lateral edge of the retention member;

FIG. 15 shows the addition of an adhesive strip on the first folded wall to attach with the first lateral edge of the retention member;

FIG. 16 shows the addition of a tab on the first folded wall to attach with the first lateral edge of the retention member.

FIG. 17 shows the addition of a tab on the first folded wall to attach with the first lateral edge of the retention member.

FIG. 18 shows a second packaging assembly including locking tabs;

FIG. 19 shows placing an object within the second packaging;

FIG. 20 shows folding first and second wings underneath a central platform of the second packaging;

FIG. 21 shows lifting third and fourth wings to engage the locking tabs of the second packaging;

FIG. 22 shows lifting third and fourth wings to engage the locking tabs of the second packaging;

FIG. 23 shows lifting third and fourth wings to engage the locking tabs of the second packaging;

FIG. 24 shows a third packaging assembly including a retention sheet attached with a frame on three sides and an opening on the fourth side;

FIG. 25 shows folding first and second wings underneath a central platform of the third packaging;

FIG. 26 shows closing the opening with the retention sheet placed over a folded side of the third packaging;

FIG. 27 shows a frame member of a fourth packaging assembly including locking tabs and locking flaps;

FIG. 28 shows the fourth packaging assembly including a retention sheet attached with the frame on three sides and an opening on the fourth side;

FIG. 29 shows a perspective view of a locking tab and locking flap on an underside of the fourth packaging member.

FIG. 30 shows the fourth packaging assembly with first and second wing portions folded beneath a central panel of the frame;

FIG. 31 shows alignment of the locking tab and the locking flap on the underside of the fourth packaging assembly;

FIG. 32 shows the locking tab engaged with the locking flap on an upper side of the fourth packaging assembly;

FIG. 33 shows a perspective view of the locking tab engaged with the locking flap on the underside of the fourth packaging assembly;

FIG. 34 shows a fifth packaging assembly including a biodegradable/compostable retention sheet attached with a frame on three sides and an opening on a fourth side;

FIG. 35 shows a sixth packaging assembly including a retention sheet attached with a frame on four sides with a bridged opening;

FIG. 36 shows the sixth packaging assembly receiving an object onto a central panel of the frame through the bridged opening.

FIG. 37 shows a jig for use with any of the packaging assembly disclosed herein.

FIG. 38 shows the jig in use with the sixth packaging assembly for receiving an object onto a central panel of the frame through the bridged opening.

FIG. 39 shows the jig in use with the sixth packaging assembly for receiving an object onto a central panel of the frame through the bridged opening.

Various examples are depicted in the accompanying drawings for illustrative purposes, and should in no way be interpreted as limiting the scope of the examples. Various features of different disclosed examples can be combined to form additional examples, which are part of this disclosure.

### DETAILED DESCRIPTION

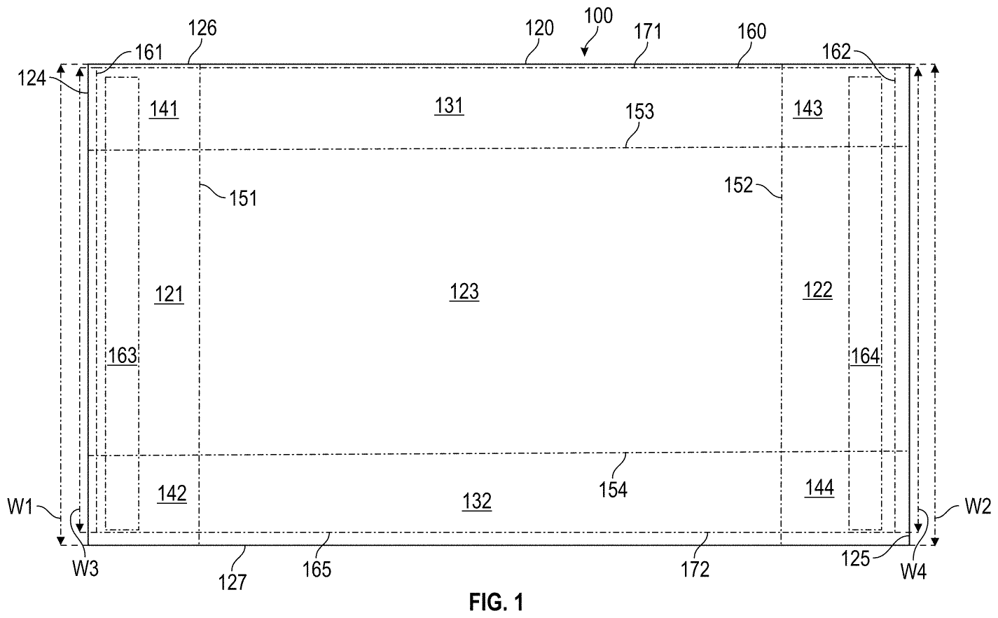

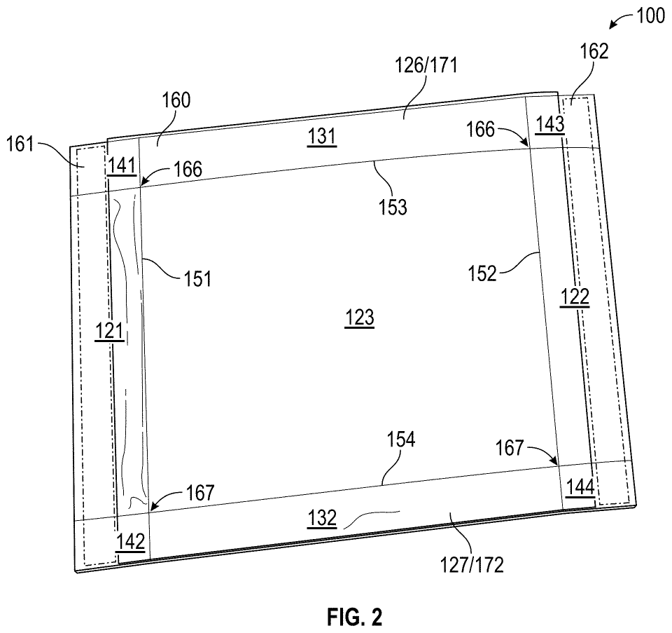

FIG. 1 illustrates a first packaging assembly 100. The packaging assembly 100 can include a frame 120. The frame 120 can be formed out of a corrugated cardboard sheet, wood pulp products, plastic or other materials. The corrugated cardboard can include a first and second outer panels and a plurality of corrugations therebetween. The frame 120 in general can be formed as a square or rectangular sheet having first and second lateral sides 126, 127 and first and second ends 124, 125. The frame 120 can include a first fold line 151. The first fold line 151 can be located on a first side of a platform 123. A second fold line 152 can be located on a second side of the platform 123. The first and second fold lines 151, 152 can be parallel. The first and second fold lines 151, 152 can extend from between outer lateral sides 126, 127 of the frame 120. The first and second fold lines 151, 152 can extend a width W1 of a first end of the frame 120 and/or a width W2 of a second end of the frame 120.

The first fold line 151 can define a first wing portion 121. The first wing portion can be pivotably connected with the platform 123 from the first fold line 151. A second wing portion 122 can be connected with the platform 123 by the second fold line 152. The second wing portion 122 can be pivotable relative to the platform about the second fold line 152.

The frame 120 can include a third fold line 153. The third fold line 153 can extend along a third side of the platform 123. The third fold line 153 can extend along a length of the frame 120 between first and second ends 124, 125 of the frame 120. The frame 120 can include a fourth fold line 154. The fourth fold line 154 can extend parallel to the third fold line 153. The fourth fold line 154 can extend along the length of the frame 120 between the first and second ends 124, 125 thereof. The third and fourth fold lines 153, 154 can be parallel. The third and fourth lines 153, 154 can be anti-parallel, transverse, or perpendicular to the second and first fold lines 151, 152. The third fold line 153 can bound a first lateral portion 131. The first lateral portion 131 can be separated from the platform 123 by the third fold line 153. The first lateral portion 131 can be pivotable with respect to the platform 123 about the third fold line 153. A second lateral portion (or fourth wing) 132 can be connected with the platform 123 about the fourth fold line 154. The second lateral portion 132 can be pivotable with respect to the platform 123 about the fold line 154. The first lateral portion 131 can extend along the first lateral side 126 of the frame 120. The second lateral portion 132 can extend along the second lateral side 127 of the frame 120.

The first fold line 151 and the third fold line 153 can also partially define a first corner portion 141. The first corner portion 141 can be located between the first wing portion 121 and the first lateral portion 131. The first corner portion 141 can be generally aligned with the first lateral portion 131 and a first wing portion 121. The first fold line 151 and the fourth fold line 154 can be bound or at least partially define a second corner portion 142. The second corner portion 142 can be aligned with the first wing portion 121 and the second lateral portion 132. The second fold line 152 and the third fold line 153 can form a third corner 143. The third corner 143 can be at least partially bounded by the second fold line 152 and the third fold line 153. The third corner 143 can be aligned with the first lateral portion 131 and the second wing portion 122. The second fold line 152 and the fourth fold line 154 can at least partially bound to define a fourth corner portion 144. The fourth corner portion 144 can be aligned with the second lateral portion 132 and the second wing portion 122. The corner portions 141-144 can be square or rectangular depending on the outer shape of the frame 120 which is generally square or rectangular, but this is not required.

The retention member 160 can be formed of a thin resilient film material such as a polymer. An exemplary material for the retention member 160 is low density polyethylene. Low density polyethylene is highly recyclable and can be heat sealed directly to an outer face of a corrugated cardboard member as described in U.S. application Ser. No. 14/222,410. The retention member 160 can be generally formed as a square or rectangular member that generally corresponds to the size and shape of the frame 120. The retention member 160 can overlay the frame 120 including the central panel platform 123, first and second wing portions 121, 122, the first and second lateral portions 131, 132, and the first, second, third, and fourth corner portions 141, 142, 143, 144.

The retention member 160 can include a first end 161 and a second 162. The first end 161 can be generally aligned with the first end 124 of the frame 120. The first end 161 can be attached with the frame 120 on the corner 141, the first wing portion 121, and/or the second corner 142. The first end 161 can include an attachment portion 163. The attachment portion 163 can extend across the first corner 141, the first wing portion 121, and/or the second corner 142. The first end 161 can have a width W3. The width W3 can be at least as great as a width of the first wing portion 121. Optionally the width W3 can be equal to the width W1 of the frame 120 on the first end 124. The first end 161 of the retention member 160 can extend from the first lateral side 126 to a second lateral side 127 of the frame 120. Optionally, the first end 161 can be aligned with the first end 124 of the frame 120. The first end 161 can also be offset from the first end 124. The second end 162 can be aligned with the second end 125 of the frame 120 or offset therefrom. The second end 162 can extend across the third corner portion 143, the second wing portion 122, and/or the fourth corner 144. The second end 162 can include an attachment portion 164. The attachment portion can extend on the third corner portion 143, the second wing portion 122, and/or the fourth corner portion 144. The second end 162 can have a width W4. The width W4 can be greater than a width of the second wing portion 122. The width W4 can be as great as the width W2 of the second end 125 frame 120. The attachment portions 163, 164 can include adhesives, staples, heat seals, or any other attachment mechanism between a resilient member and corrugated cardboard or other types of materials.

A central portion 165 of the retention member 160 can overlay the platform 123 and/or other portions of the frame 120. The central portion 165 is not attached with the frame 120 or otherwise overlays the frame 120 such that an article can be placed between the platform 123 and the central portion 165 of the retention member 160.

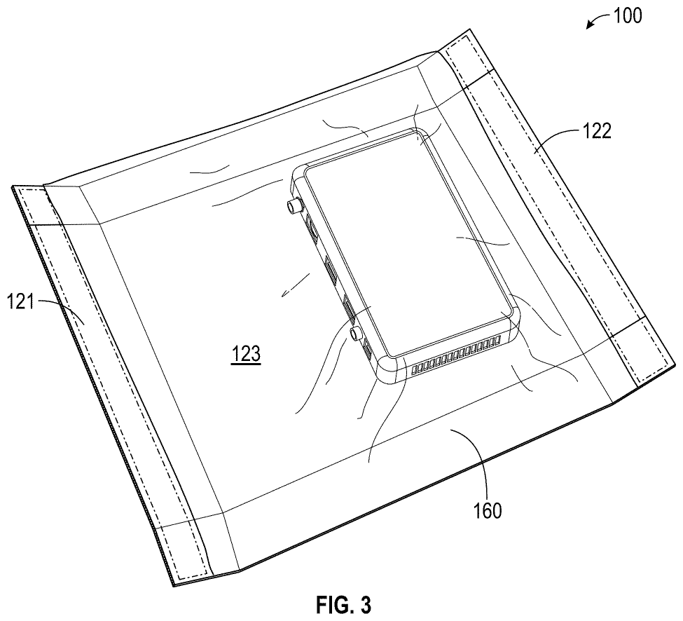

As shown in FIG. 3, an article for a transport can be placed between the retention member 160 and the frame 120. Specifically, the article can be placed between the central portion 165 of the retention member 160 and the platform 123 of the frame 120. To place the article, it may be necessary to fold the first wing portion 122 and the second wing portion 122 upwardly along the first and second fold lines 151, 152 as shown in FIG. 3 to provide slack in the retention member 160. Once the article is installed, the first wing portion 121 can be folded downwardly along the first fold line 151 and the second wing portion 122 can be folded downwardly along the second fold line 152. The first corner and the second corner 141, 142 can be folded along with the first wing portion 121. The third corner 143 and the fourth corner 144 can be folded along with the second wing portion 122.

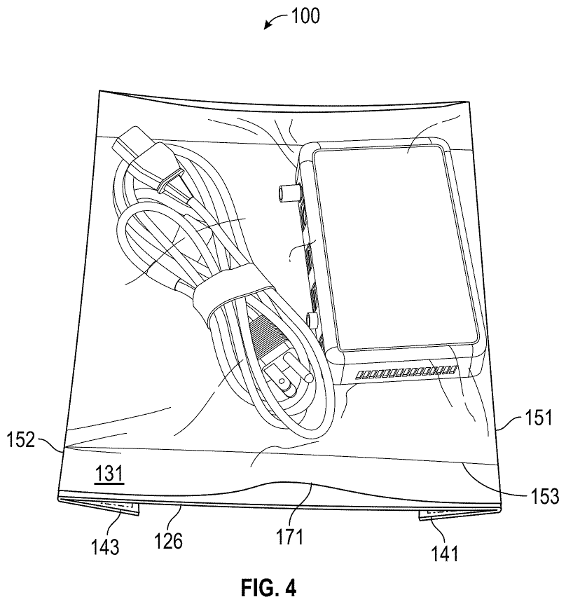

As shown in FIG. 4, the first wing portion 121 can be folded against an underside of the platform 123. Likewise, the first corner 141 can be folded against the underside of the first lateral portion 131 and the second corner portion 142 can be folded against an underside of the second lateral portion 132. Similarly the second wing portion 122 can be folded against the underside of the platform 123, the third corner 143 can be folded against an underside of the first lateral portion 131, and the fourth corner 144 can be folded against an underside of the second lateral portion 132.

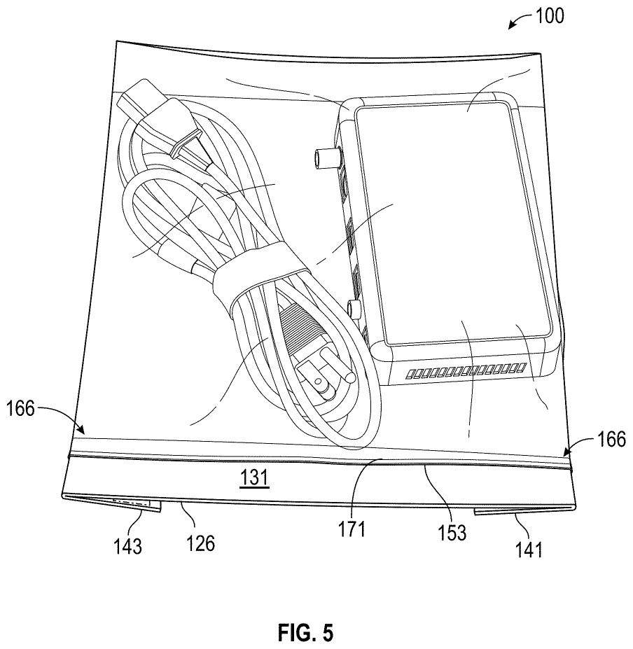

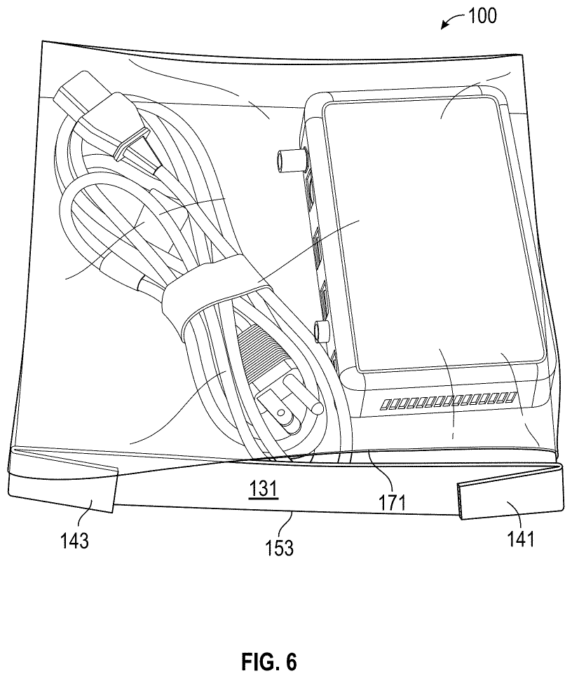

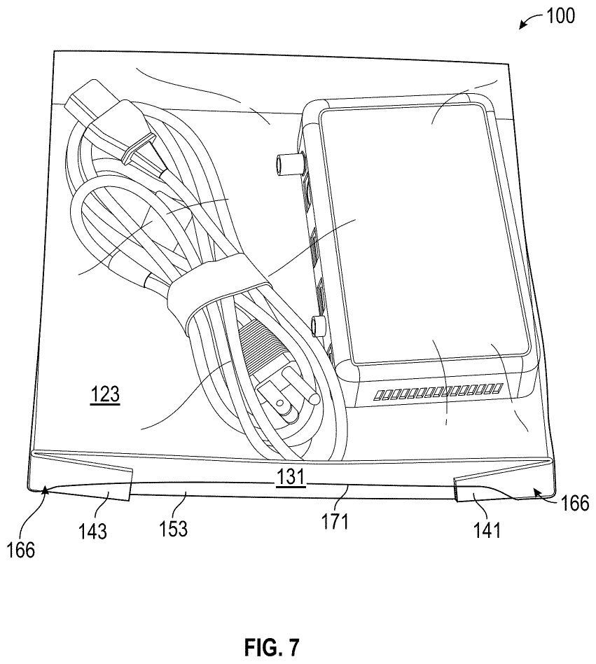

As shown in FIGS. 5-7 the first corner 141 and the third corner 143 can be folded upwardly along the third fold line 153 to form a first folded wall that bounds one edge of the platform. The first folded wall can be vertical and/or perpendicular relative to the platform 123. The first lateral edge 171 of the retention member 160 can be stretched upwardly over the first folded wall to an exterior side thereof. The attachment portions 163, 164 can be positioned on the exterior side of the first folded wall. To facilitate stretching of the retention member 160, the retention member 160 can include slack portions 166, 167. The slack portions 166, 167 can be aligned along the first lateral edge 171 and/or the second lateral edge 172. The slack portions 166, 167 can overlap the respective corners 141, 143 and 142, 144.

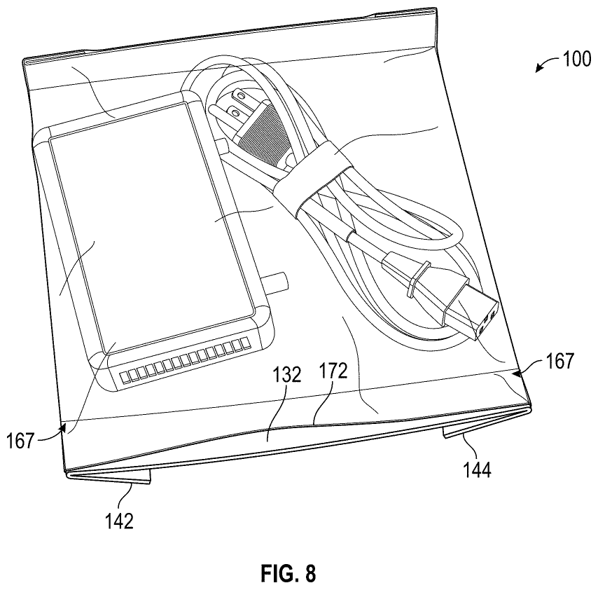

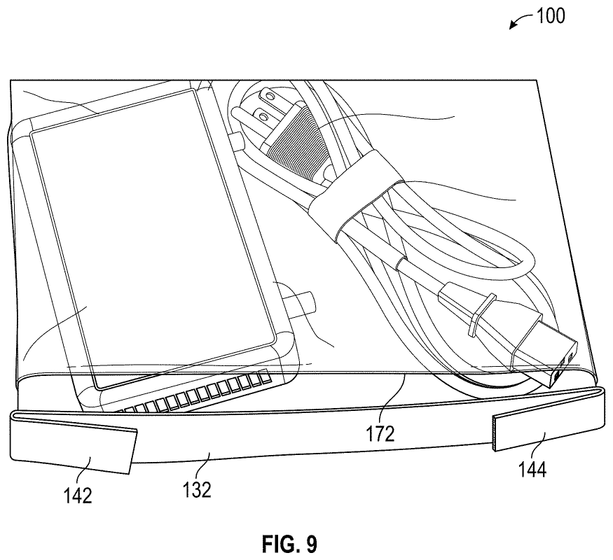

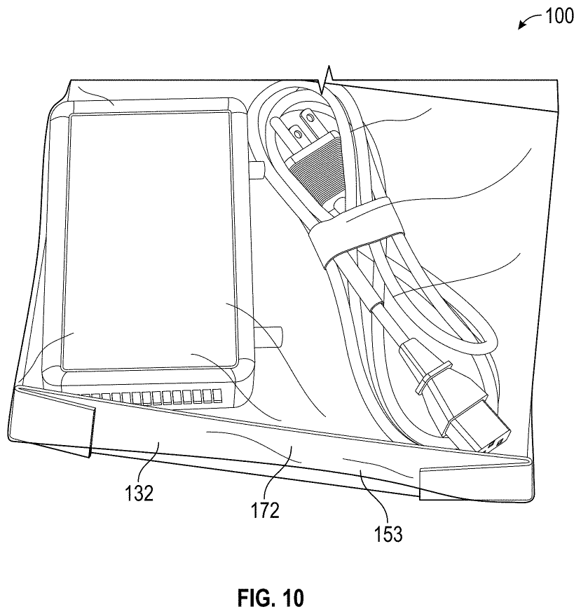

As shown in FIGS. 8-10, the second lateral portion 132 and the second corner 142 and the fourth corner 144 can be folded upwardly along the fourth fold line 154 to form a second folded wall on the platform 123. The second folded wall can be vertical and/or perpendicular relative to the platform 123. The second folded wall can be opposite the first folded wall. The second lateral edge 172 of the retention member 160 can be stretched upwardly and over the second folded wall. The attachment portions 163, 164 can be positioned on the exterior side of the second folded wall.

Stretching the first and second lateral sides 171, 172 over the respective folded walls is enabled by including excess material (e.g., slack portions 166, 167) in the retention member 160. The first and second ends 161, 162 of the retention member 160 extend laterally past the wing portions 121, 122. The first and second ends 161, 162 can extend all the way past the wing portions 121, 122 onto the corner portions and/or to the lateral edges 126, 127. This excess material can be stretched upwardly over the folded walls as shown in the figures and described above. A user can insert their fingers underneath the lateral edges 171, 172 of the retention member 160, stretch the edges upwardly and outwardly onto an exterior side of the folded wall. This stretching may include stretching of the material of the retention member 160 and/or folding of the material over the folded walls, depending on the material type. The stretching and/or folding of the retention member 160 can further tension the retention member 160 to retain articles on the platform between the retention member 160 and the platform 123. The stretching and folding of the lateral edges 171, 172 over the folded walls also retains the folded wall in an upright configuration. In the upright configuration the folded wall can be generally perpendicular with the central panel although this is not strictly required. The stretching and placing of the first lateral edges 171, 172 also can allow the retention member 160 to act as a barrier to liquids, dust, and other items that may come into contact with the articles stored within the packaging 100.

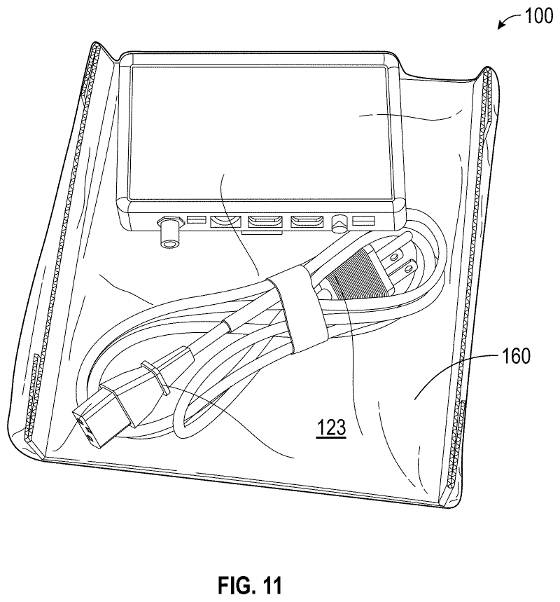

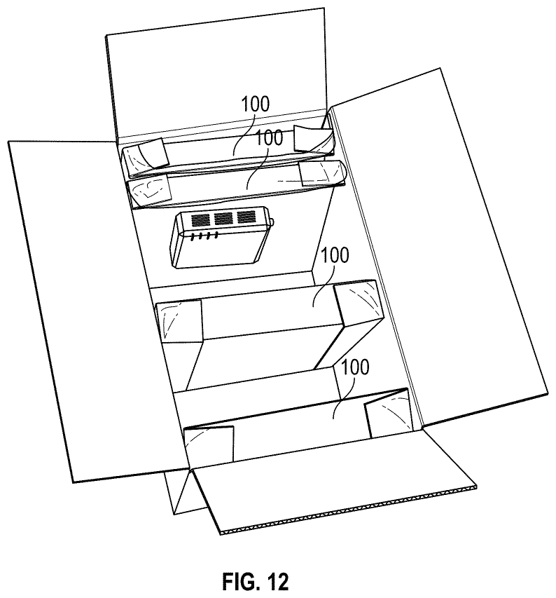

As shown in FIG. 11 the completed, enclosed assembly can be stored for transport such as within a package or box as shown in FIG. 12.

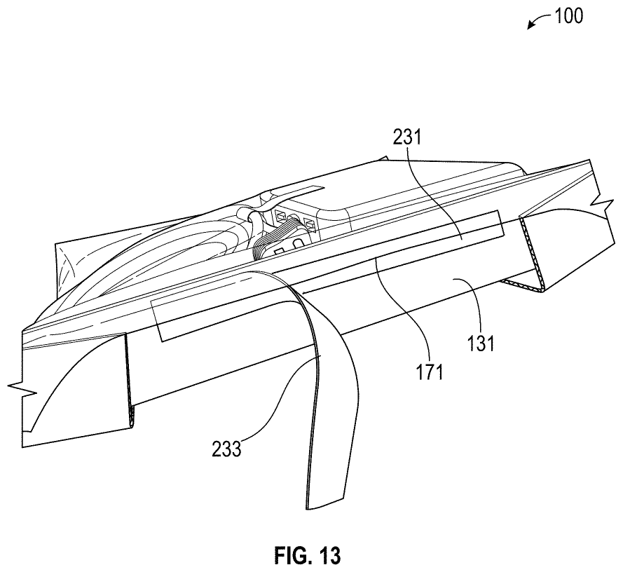

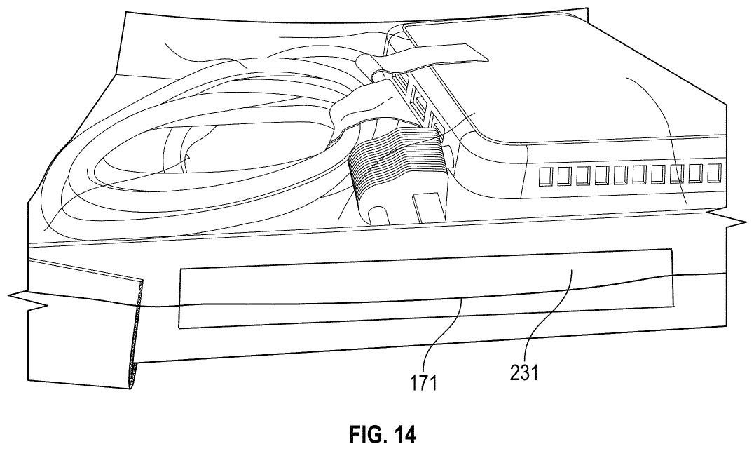

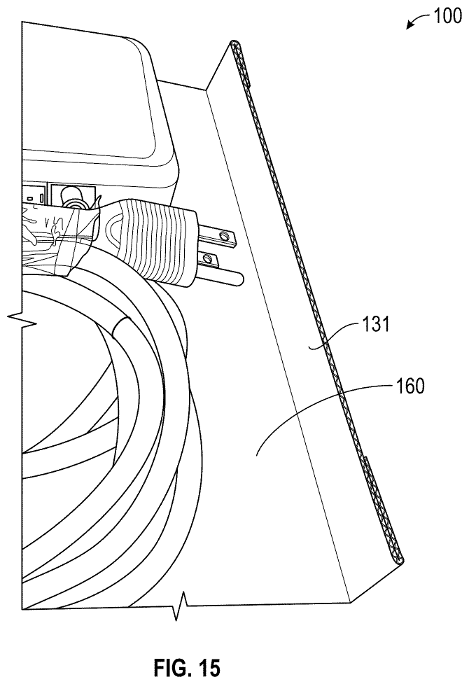

FIGS. 13-15 show an adhesive strip 231 on the first folded wall. The adhesive strip 231 can be attached with the first lateral portion 131. The adhesive strip 231 can be attached on an under side of the first lateral portion 131 such that the adhesive strip 231 is positioned on an outward exterior side of the first folded wall. The adhesive strip 231 can extend from the first corner 141 to the third corner 143. The adhesive strip 231 can extend the length of the first lateral portion 131. Optionally, the first corner portion 141 and the third corner portion 143 can be adhered in place in the first folded wall by the adhesive strip 231. The adhesive strip 231 can include a removable paper 233. After or during the forming of the enclosed tray, the removable paper can be removed and the lateral edge 171 can be attached with first folded wall (e.g., on the first lateral portion 131) by contact with the adhesive strip. The second folded wall can similarly include an adhesive strip (not shown). The adhesive strip 231 can ensure the positioning of the lateral edge 171 over the folded wall and can allow the retention member 160 to act as a barrier to liquids, dust, and other items that may come into contact with the articles stored within the packaging 100. In other implementations, the lateral edge 171 can be attached with the first folded wall by staples, applied adhesive (e.g., liquid), heat sealing, or other mechanical attachment means.

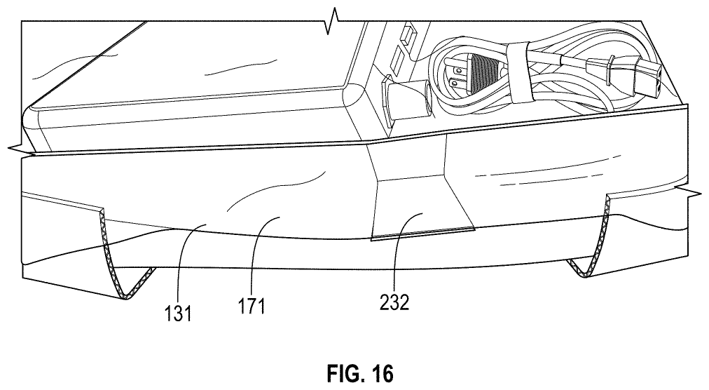

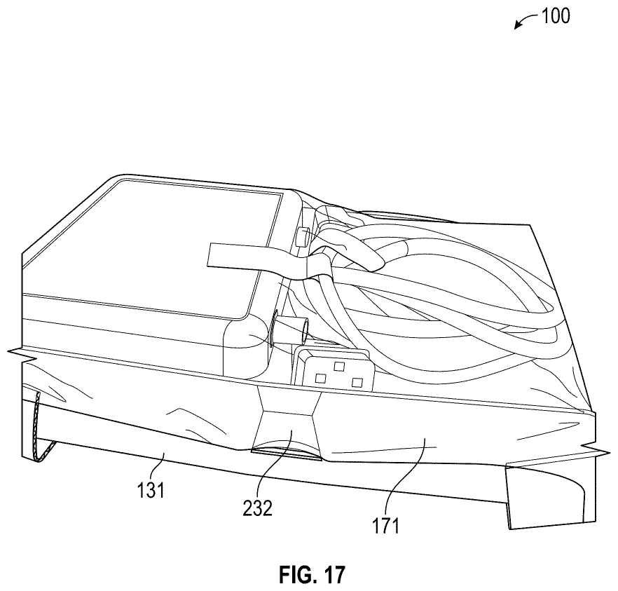

FIGS. 16-17 show at least one tab 232 on the first folded wall. The tab 232 can be a cutout portion of the first lateral portion 131. The tab 232 can include an upper end attached with the first lateral portion and a cutout end. The cutout end can be wedge shaped. After or during the forming of the enclosed tray, the cutout end can be lifted out of the first lateral portion 131 and the lateral edge 171 can be placed under the cutout end. The cutout end can then be pressed back into the first lateral portion 131, as shown in FIG. 17 to secure the position of the first lateral edge 171. The second folded wall can similarly include a tab (not shown). The tab 232 can ensure the positioning of the lateral edge 171 over the folded wall and can allow the retention member 160 to act as a barrier to liquids, dust, and other items that may come into contact with the articles stored within the packaging 100.

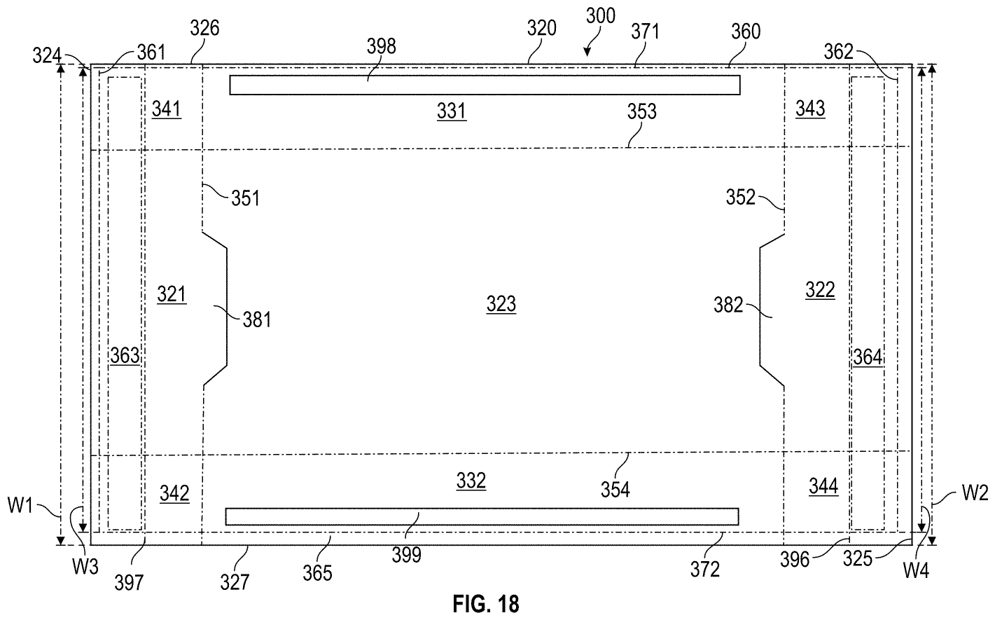

FIGS. 18-23 illustrates a second packaging assembly 300. The packaging assembly 300 can include a frame 320. The frame 320 can be formed out of a corrugated cardboard sheet, wood pulp products, plastic or other materials. The corrugated cardboard can include a first and second outer panels and a plurality of corrugations therebetween.

The frame 320 in general can be formed as a square or rectangular sheet having first and second lateral sides 326, 327 and first and second ends 324, 325. The frame 320 can include a first fold line 351. The first fold line 351 can be located on a first side of a platform 323. A second fold line 352 can be located on a second side of the platform 323. The first and second fold lines 351, 352 can be parallel. The first and second fold lines 351, 352 can extend between outer lateral sides 326, 327 of the frame 320. The first and second fold lines 351, 352 can extend a width W1 of a first end of the frame 320 and/or a width W2 of a second end of the frame 320.

The first fold line 351 can include a first cutout tab 381. The tab 381 can be separated from a portion of the platform 323. The tab 381 can extend laterally inwardly from the first fold line 351 towards a center of the platform 323. The second fold line 352 can include a second cutout tab 382. The tab 382 can be separated from a portion of the platform 323. The tab 382 can extend laterally inwardly from the second fold line 352 towards a center of the platform 323.

The first fold line 351 can define a first wing portion 321. The first wing portion can be pivotably connected with the platform 323 from the first fold line 351. The tab 381 can be a portion of the wing 321. A second wing portion 322 can be connected with the platform 323 by the second fold line 352. The second wing portion 322 can be pivotable relative to the platform about the second fold line 352. The tab 382 can be a portion of the wing 322.

The frame 320 can include a third fold line 353. The third fold line 353 can extend along a third side of the platform 323. The third fold line 353 can extend along a length of the frame 320 between first and second ends 324, 325 of the frame 320. The frame 320 can include a fourth fold line 354. The fourth fold line 354 can extend parallel to the third fold line 353. The fourth fold line 354 can extend along the length of the frame 320 between the first and second ends 324, 325 thereof. The third and fourth fold lines 353, 354 can be parallel. The third and fourth lines 353, 354 can be anti-parallel, transverse, or perpendicular to the second and first fold lines 351, 352. The third fold line 353 can bound a first lateral portion (or third wing) 331. The first lateral portion 331 can be separated from the platform 323 by the third fold line 353. The first lateral portion 331 can be pivotable with respect to the platform 323 about the third fold line 353. A second lateral portion (or fourth wing) 332 can be connected with the platform 323 about the fourth fold line 354. The second lateral portion 332 can be pivotable with respect to the platform 323 about the fold line 354. The first lateral portion 331 can extend along the first lateral side 326 of the frame 320. The second lateral portion 332 can extend along the second lateral side 327 of the frame 320.

The first fold line 351 and the third fold line 353 can also partially define a first corner portion 341. The first corner portion 341 can be located between the first wing portion 321 and the first lateral portion 331. The first corner portion 341 can be generally aligned with the first lateral portion 331 and a first wing portion 321. The first fold line 351 and the fourth fold line 354 can be bound or at least partially define a second corner portion 342. The second corner portion 342 can be aligned with the first wing portion 321 and the second lateral portion 332. The second fold line 352 and the third fold line 353 can form a third corner 343. The third corner 343 can be at least partially bounded by the second fold line 352 and the third fold line 353. The third corner 343 can be aligned with the first lateral portion 331 and the second wing portion 322. The second fold line 352 and the fourth fold line 354 can at least partially bound to define a fourth corner portion 344. The fourth corner portion 344 can be aligned with the second lateral portion 332 and the second wing portion 322. The corner portions 341-144 can be square or rectangular depending on the outer shape of the frame 320 which is generally square or rectangular, but this is not required.

The retention member 360 can be formed of a thin resilient film material such as a polymer. An exemplary material for the retention member 360 is low density polyethylene. Low density polyethylene is highly recyclable and can be heat sealed directly to an outer face of a corrugated cardboard member as described in U.S. application Ser. No. 34/222,410. The retention member 360 can be generally formed as a square or rectangular member that generally corresponds to the size and shape of the frame 320. The retention member 360 can overlay the frame 320 including the central panel platform 323, first and second wing portions 321, 322, the first and second lateral portions 331, 332, and the first, second, third, and fourth corner portions 341, 342, 343, 344.

The retention member 360 can include a first end 361 and a second end 362. The first end 361 can be generally aligned with the first end 324 of the frame 320. The first end 361 can be attached with the frame 320 on the corner 341, the first wing portion 321, and/or the second corner 342. The first end 361 can include an attachment portion 363. The attachment portion 363 can extend across the first corner 341, the first wing portion 321, and/or the second corner 342. The first end 361 can have a width W3. The width W3 can be at least as great as a width of the first wing portion 321. Optionally the width W3 can be equal to the width W1 of the frame 320 on the first end 324. The first end 361 of the retention member 360 can extend from the first lateral side 326 to a second lateral side 327 of the frame 320. Optionally, the first end 361 can be aligned with the first end 324 of the frame 320. The first end 361 can also be offset from the first end 324.

The second end 362 can be aligned with the second end 325 of the frame 320 or offset therefrom. The second end 362 can extend across the third corner portion 343, the second wing portion 322, and/or the fourth corner 344. The second end 362 can include an attachment portion 364. The attachment portion 364 can extend on the third corner portion 343, the second wing portion 322, and/or the fourth corner portion 344. The second end 362 can have a width W4. The width W4 can be greater than a width of the second wing portion 322. The width W4 can be as great as the width W2 of the second end 325 frame 320. The attachment portions 363, 364 can include adhesives, staples, pressure sensitive strips, heat seals, pockets, or any other attachment mechanism between a resilient member and corrugated cardboard or other types of materials.

The first wing portion 321 can include a seal fold line 397. The seal fold line 397 can extend from the lateral side 327 to the lateral side 326. The seal fold line 397 can be located between the attachment portion 363 and the fold line 351. In use, the attachment portion 363 and that portion of the first wing portion 321 can be folded along the seal fold line 397. This folding can enhance the connection of the first end 361 of the sheet 360 with the first wing portion 321. The second wing portion 322 can include a seal fold line 396. The seal fold line 396 can extend from the lateral side 327 to the lateral side 326. The seal fold line 396 can be located between the attachment portion 364 and the fold line 352. In use, the attachment portion 364 and that portion of the second wing portion 322 can be folded along the seal fold line 396. This folding can enhance the connection of the second end 362 of the sheet 360 with the second wing portion 322. Folding along the seal fold line 397 and/or 396 can be executed before folding along the fold lines 353, 354 as described further below. This can lock the folded portions in place along the seal fold lines 396, 397.

A central portion 365 of the retention member 360 can overlay the platform 323 and/or other portions of the frame 320. The central portion 365 is not attached with the frame 320 or otherwise overlays the frame 320 such that an article can be placed between the platform 323 and the central portion 365 of the retention member 360. Lateral edges 371, 372 can extend between the first and second ends 361, 362. The lateral edges 371, 372 can be unattached with the lateral portion 331, 332. Optionally, one or both of the lateral portions can include attachment mechanisms for attaching one or both of the lateral edge 371, 372 with the respective lateral portions 331, 332. The attachment mechanism may include an adhesive strip 398, 399 covered by a removable protective sheet. The attachment mechanism may include a tab, like the tab 232. Alternatively, the attachment mechanism may include a staple or other mechanical fastener.

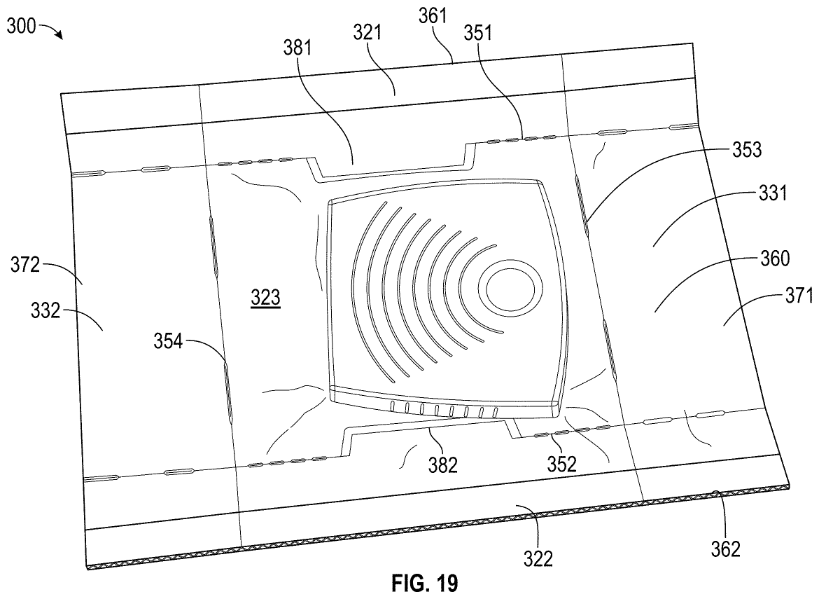

An article for a transport can be placed between the retention member 360 and the frame 320. Specifically, the article can be placed between the central portion 365 of the retention member 360 and the platform 323 of the frame 320. To place the article, it may be necessary to fold the first wing portion 322 and the second wing portion 322 upwardly along the first and second fold lines 351, 352 as shown in FIG. 19 to provide slack in the retention member 360. The article can be passed through either the lateral edge 371 or the lateral edge 372. Once the article is installed, the attachment mechanism can be engaged (e.g., removal of the paper from the adhesive strip(s) 398, 399) to secure the lateral edges to the respective lateral portions 331, 332. The first lateral portion 331 can be folded downwardly along the third fold line 353 and the second lateral portion 332 can be folded downwardly along the fourth fold line 354. The first corner and the third corner 341, 343 can be folded along with the first lateral portion 331. The second corner 342 and the fourth corner 344 can be folded along with the second lateral portion 332. The folding of the first and second lateral portions 331, 332 with the attachment portions 363, 364 extended on the respective corner portions can stretch and/or tension the retention member 360. This is in contrast to a conventional suspension packaging assembly that would generally apply tension using the wing portions attached with the ends of the retention sheet.

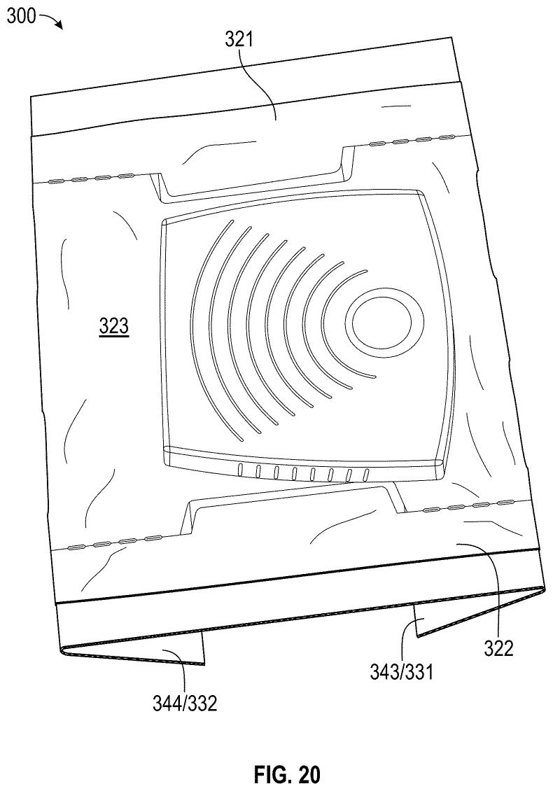

As shown in FIG. 20, the first lateral portion 331 can be folded against an underside of the platform 323. Likewise, the first corner 341 can be folded against the underside of the first wing portion 321 and the third corner portion 343 can be folded against an underside of the second wing portion 322. Folding the first lateral portion 331 can bend and close the first lateral edge 371 and thereby enclose one side of the platform 323. Similarly the second lateral portion 332 can be folded against the underside of the platform 323, the second corner 342 can be folded against an underside of the first wing portion 321, and the fourth corner 344 can be folded against an underside of the second wing portion 322. Folding the second lateral portion 332 can bend and close the second lateral edge 372 and thereby enclose one side of the platform 323.

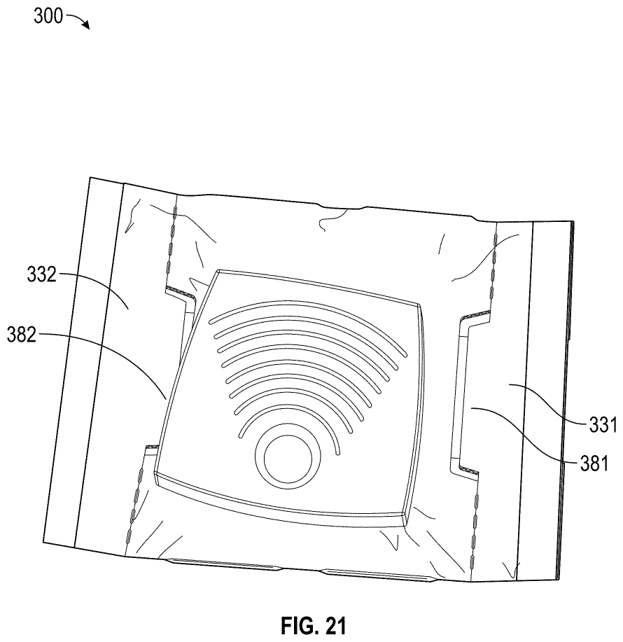

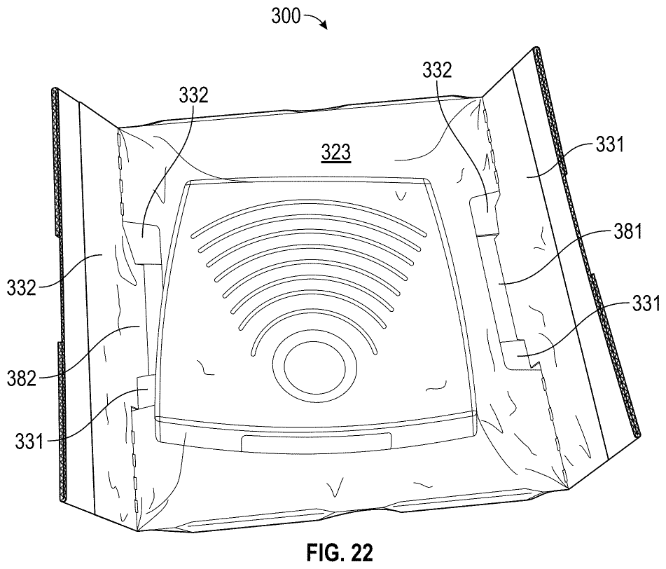

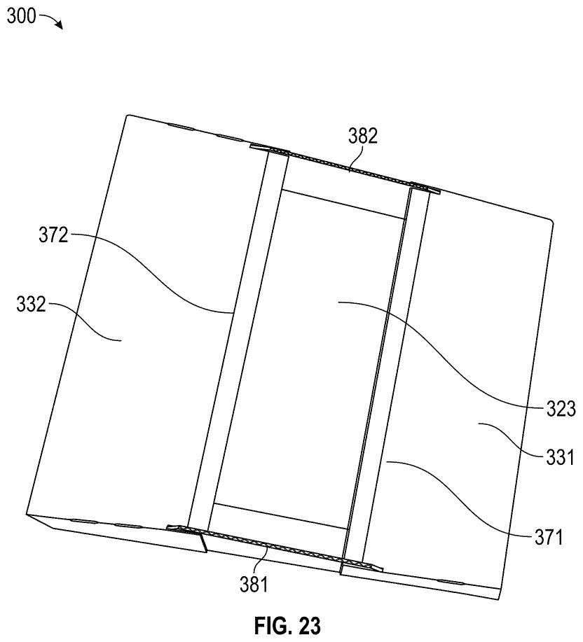

As shown in FIGS. 21-22 the first corner 341 and the second corner 342 can be folded upwardly along the first fold line 351 to form a first folded wall that bounds one edge of the platform 323. The first folded wall can be vertical and/or perpendicular relative to the platform 323. The first folded wall can be held in place by the tab 381. The tab 381 can fold downwardly under the platform 323, as shown in FIG. 23. The tab 381 can fold past the first and second lateral portion 331, 332 folded underneath the platform 323. The tab 381 can engage with edges 326, 327 along the first and second lateral portions 331, 332 to hold the first folded wall in place.

The third corner 343 and the fourth corner 344 can be folded upwardly along the second fold line 352 to form a second folded wall that bounds one edge of the platform 323. The second folded wall can be vertical and/or perpendicular relative to the platform 323. The second folded wall can be held in place by the tab 382. The tab 382 can fold downwardly under the platform 323, as shown in FIG. 23. The tab 382 can fold past the first and second lateral portion 331, 332 folded underneath the platform 323 (e.g., opposite tab 381). The tab 382 can engage with edges 326, 327 along the first and second lateral portions 331, 332 to hold the second folded wall in place.

By folding the first and second lateral portions first along the third and fourth fold lines 353, 354 to close open ends of the retention sheet, and folding the first and second fold wings (with the connected first and second ends 361, 362) along the first and second fold lines, the platform 323 can be enclosed on all four sides to contain an item for shipping. Advantageously, this can be performed with fewer intricate steps than certain other packaging solutions.

As shown in FIG. 22 the completed, enclosed assembly 300 can be stored for transport such as within a package or box as shown in FIG. 12.

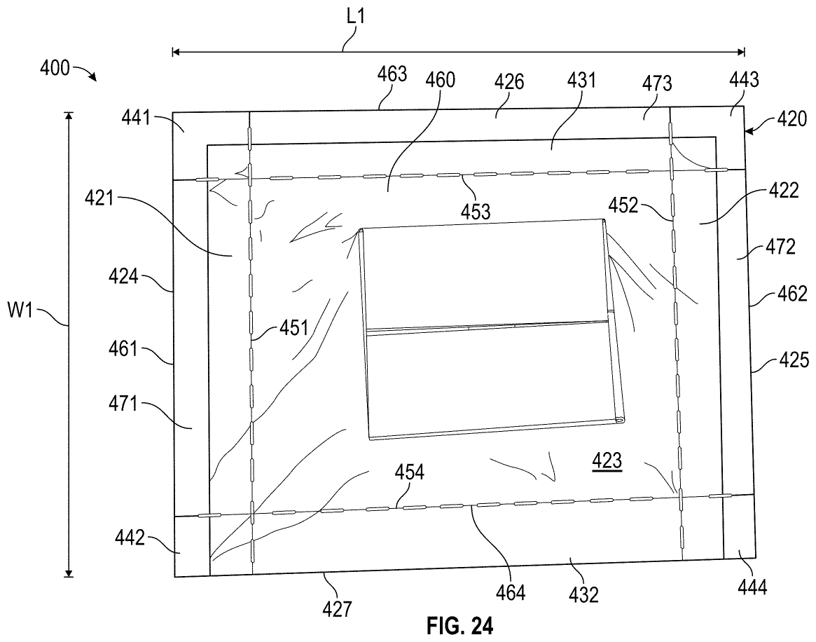

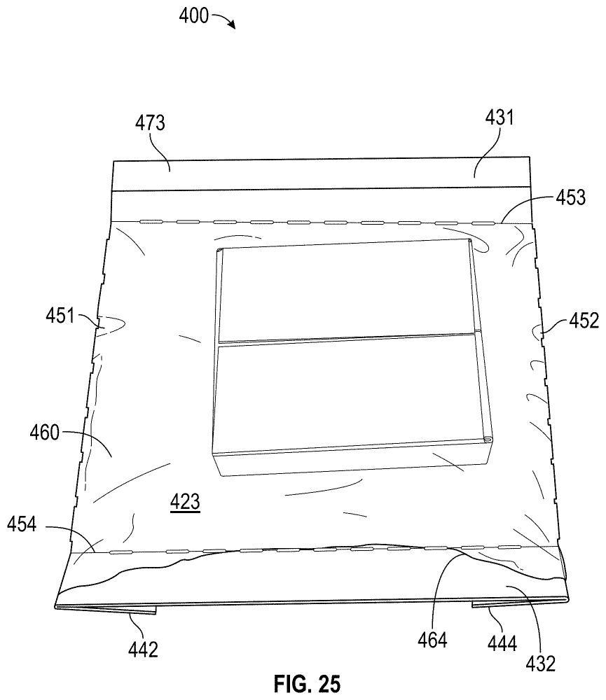

FIG. 24-26 illustrates a third packaging assembly 400. The packaging assembly 400 can include a frame 420. The frame 420 can be formed out of a corrugated cardboard sheet, wood pulp products, plastic or other materials. The frame 420 can be formed as a square or rectangular sheet having first and second lateral sides 426, 427 and first and second ends 424, 425. The frame 420 can include a first fold line 451. The first fold line 451 can be located on a first side of a platform 423. A second fold line 452 can be located on a second side of the platform 423. The first and second fold lines 451, 452 can be parallel. The first and second fold lines 451, 452 can extend from between outer lateral sides 426, 427 of the frame 420. The first and second fold lines 451, 452 can extend a width W1 of the first end of the frame 420 and/or a width of the second end of the frame 420. The first fold line 451 can define a first wing portion 421. The first wing portion can be pivotably connected with the platform 423 from the first fold line 451. A second wing portion 422 can be connected with the platform 423 by the second fold line 452. The second wing portion 422 can be pivotable relative to the platform about the second fold line 452.

The frame 420 can include a third fold line 453. The third fold line 453 can extend along a third side of the platform 423. The third fold line 453 can extend along a length of the frame 420 between first and second ends 424, 425 of the frame 420. The frame 420 can include a fourth fold line 454. The fourth fold line 454 can extend parallel to the third fold line 453. The fourth fold line 454 can extend along the length of the frame 420 between the first and second ends 424, 425 thereof. The third and fourth fold lines 453, 454 can be parallel. The third and fourth lines 453, 454 can be anti-parallel, transverse, or perpendicular to the second and first fold lines 451, 452. The third fold line 453 can bound a first lateral portion (or third wing) 431. The first lateral portion 431 can be separated from the platform 423 by the third fold line 453. The first lateral portion 431 can be pivotable with respect to the platform 423 about the third fold line 453. A second lateral portion (or fourth wing) 432 can be connected with the platform 423 about the fourth fold line 454. The second lateral portion 432 can be pivotable with respect to the platform 423 about the fold line 454. The first lateral portion 431 can extend along the first lateral side 426 of the frame 420. The second lateral portion 432 can extend along the second lateral side 427 of the frame 420.

The first fold line 451 and the third fold line 453 can also partially define a first corner portion 441. The first corner portion 441 can be located between the first wing portion 421 and the first lateral portion 431. The first corner portion 441 can be generally aligned with the first lateral portion 431 and a first wing portion 421. The first fold line 451 and the fourth fold line 454 can be bound or at least partially define a second corner portion 442. The second corner portion 442 can be aligned with the first wing portion 421 and the second lateral portion 432. The second fold line 452 and the third fold line 453 can form a third corner 443. The third corner 443 can be at least partially bounded by the second fold line 452 and the third fold line 453. The third corner 443 can be aligned with the first lateral portion 431 and the second wing portion 422. The second fold line 452 and the fourth fold line 454 can at least partially bound to define a fourth corner portion 444. The fourth corner portion 444 can be aligned with the second lateral portion 432 and the second wing portion 422. The corner portions 441-144 can be square or rectangular depending on the outer shape of the frame 420 which is generally square or rectangular, but this is not required.

The retention member 460 can be formed of a thin resilient film material such as a polymer. An exemplary material for the retention member 460 is low density polyethylene. Low density polyethylene is highly recyclable and can be heat sealed directly to an outer face of a corrugated cardboard member as described in U.S. application Ser. No. 44/222,410. The retention member 460 can be generally formed as a square or rectangular member that generally corresponds to the size and shape of the frame 420. The retention member 460 can overlay the frame 420 including the central panel platform 423, first and/or second wing portions 421, 422, the first and/or second lateral portions 431, 432, and/or the first, second, third, and/or fourth corner portions 441, 442, 443, 444.

The retention member 460 can include a first end 461 and a second end 462. The first end 461 can be generally aligned with the first wing 421 of the frame 420. The first end 461 can be attached with the frame 420 on the corner 441, the first wing portion 421, and/or the second corner 442. The first end 461 can include an attachment portion 471. The attachment portion 471 can extend across the first corner 441, the first wing portion 421, and/or the second corner 442. The first end 461 can have a width. The width can be at least as great as a width of the first wing portion 421. Optionally the width can be equal to the width of the frame 420 on the first end 424. Alternatively, the attachment portion 471 can be located only on the first wing 421. In another alternative, the attachment portion 471 can comprise one or more discrete attachment points on the first wing 421, the first corner 441 or the second corner 442.

The first end 461 of the retention member 460 can extend from the first lateral side 426 to the second lateral side 427 of the frame 420. Optionally, the first end 461 can be aligned with the first end 424 of the frame 420. The first end 461 can also be offset from the first end 424. The second end 462 can be aligned with the second end 425 of the frame 420 or offset therefrom. The second end 462 can extend across the third corner portion 443, the second wing portion 422, and/or the fourth corner 444. The second end 462 can include an attachment portion 472. The attachment portion 472 can extend on the third corner portion 443, the second wing portion 422, and/or the fourth corner portion 444. The second end 462 can have a width. The width can be greater than a width of the second wing portion 422. The width can be as great as the width of the second end 425 frame 420. Alternatively, the attachment portion 472 can be located only on the second wing 422. In another alternative, the attachment portion 472 can comprise one or more discrete attachment points on the second wing 422, the third corner 443 or the fourth corner 444.

A third end 463 of the retention member 460 can extend from the first end 424 to the second 425 of the frame 420. The third end 463 can also be offset or aligned with the third side 426. The third end 463 can extend across the third corner portion 443, the first lateral portion 431, and/or the first corner 441. The third end 463 can include an attachment portion 473. The attachment portion 473 can extend on the third corner portion 443, the first lateral portion 431, and/or the first corner portion 441. The third end 463 can have a width. The width can be greater than a width of the second wing portion 422. Alternatively, the attachment portion 473 can be located only on the first lateral portion 431. In another alternative, the attachment portion 473 can comprise one or more discrete attachment points on the first lateral portion 431, the third corner 443 or the first corner 441.

The attachment portions 471-473 can include adhesives, staples, pressure sensitive strips, heat seals, or any other attachment mechanism between a resilient member and corrugated cardboard or other types of materials. Together the attachment portions 471-473 can enclose three sides of the frame 420 extending across the first wing portion 421, the first lateral portion 431 and the second wing portion 422 (and/or the corner portions 441-442). A central portion of the retention member 460 can overlay the platform 423 and/or other portions of the frame 420. The central portion is not attached with the frame 420 or otherwise overlays the frame 420 such that an article can be placed between the platform 423 and the central portion of the retention member 460.

A fourth side 464 of the retention sheet 460 can be aligned along the second lateral side 427. The fourth side 464 can be unattached with the frame 120. Alternatively, the fourth side 464 can include at least a portion that is unattached as it aligns with the second lateral portion 432.

The unattached fourth side 464 can create an opening beneath the central portion of the retention sheet 460 to allow placement of an article on the central platform 423 (as illustrated in FIGS. 24-26. To place the article, it may be necessary to fold the first wing portion 422 and the second wing portion 422 upwardly along the first and second fold lines 451, 452 to provide slack in the retention member 460. Once the article is installed, the first wing portion 421 can be folded downwardly along the first fold line 451 and the second wing portion 422 can be folded downwardly along the second fold line 452. The first corner and the second corner 441, 442 can be folded along with the first wing portion 421. The third corner 443 and the fourth corner 444 can be folded along with the second wing portion 422.

The first wing portion 421 can be folded against an underside of the platform 423. Likewise, the first corner 441 can be folded against the underside of the first lateral portion 431 and the second corner portion 442 can be folded against an underside of the second lateral portion 432. Similarly the second wing portion 422 can be folded against the underside of the platform 423, the third corner 443 can be folded against an underside of the first lateral portion 431, and the fourth corner 444 can be folded against an underside of the second lateral portion 432.

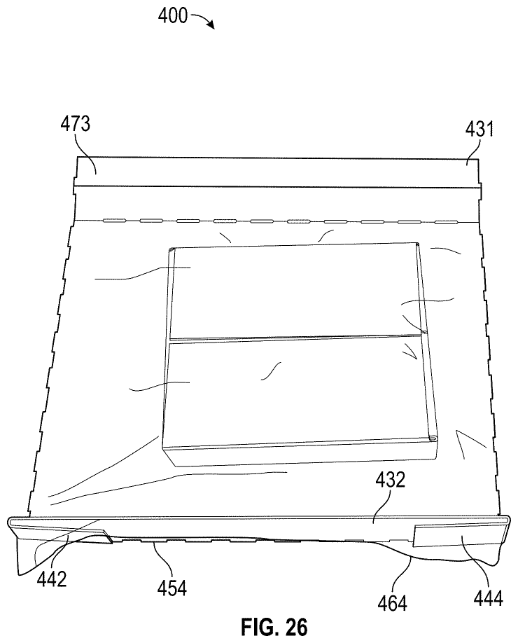

The second lateral portion 432 and the second corner 442 and the fourth corner 444 can be folded upwardly along the fourth fold line 454 to form a first folded wall on the platform 423. The first folded wall can be vertical and/or perpendicular relative to the platform 423. The second folded wall can be opposite the first lateral portion 431. The edge 464 of the retention member 460 can be stretched upwardly and over the first folded wall, as shown in FIG. 26 (e.g., over the end with the second corner 442 and the end with the fourth corner 444). Stretching the side 464 over the first folded wall is enabled by including excess material in the retention member 460. The first and second ends 461, 462 of the retention member 460 extend laterally past the wing portions 421, 422. The first and second ends 461, 462 can extend all the way past the wing portions 421, 422 onto the corner portions and/or to the lateral edges 426, 427. This excess material can be stretched upwardly over the folded walls as shown in the figures and described above. A user can insert their fingers underneath the edge 464 of the retention member 460, stretch the edge upwardly and outwardly onto an exterior side of the first folded wall. This stretching may include stretching of the material of the retention member 460 and/or folding of the material over the folded walls, depending on the material type. The stretching and/or folding of the retention member 460 can further tension the retention member 460 to retain articles on the platform between the retention member 460 and the platform 423. The stretching and folding of the edge 464 over the folded walls also retains the folded wall in an upright configuration. In the upright configuration the folded wall can be generally perpendicular with the central panel although this is not strictly required. The stretching and placing of the sheet 460 also can allow the retention member 460 to act as a barrier to liquids, dust, and other items that may come into contact with the articles stored within the packaging 400. The attachment portion 472 can enclose the side of the frame opposite the first folded wall.

In certain implementations, an adhesive strip can be attached with the second lateral portion 432 or elsewhere on the first folded wall. The adhesive strip can be positioned on an outward exterior side of the first folded wall. The adhesive strip can extend from the second corner 442 to the fourth corner 444. The adhesive strip can include a removable paper. After or during the forming of the enclosed tray, the removable paper can be removed and the lateral edge 464 can be attached with first folded wall (e.g., on the second lateral portion 432) by contact with the adhesive strip. In other implementations, the fourth edge 464 can be attached with the first folded wall by staples, applied adhesive (e.g., liquid), heat sealing, or other mechanical attachment means.

In another implementation, at least one tab can be included on the first folded wall. The tab can be a cutout portion of the second lateral portion 432. The tab can include an upper end attached with the second lateral portion 432 and a cutout end. The cutout end can be wedge shaped. After or during the forming of the enclosed tray, the cutout end can be lifted out of the second lateral portion 432 and the fourth edge 464 can be placed under the cutout end. The cutout end can then be pressed back into the second lateral portion 432, as shown in FIG. 17 to secure the position of the edge 464.

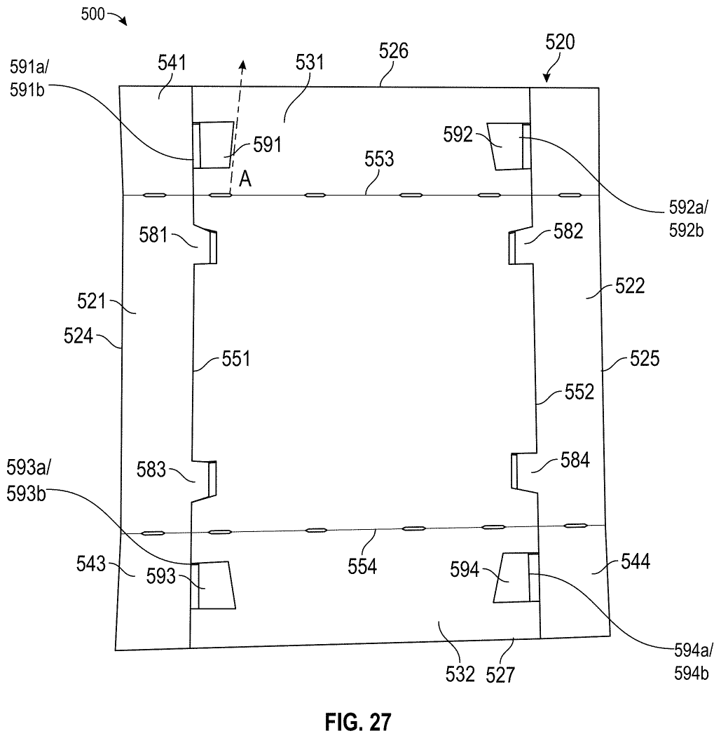

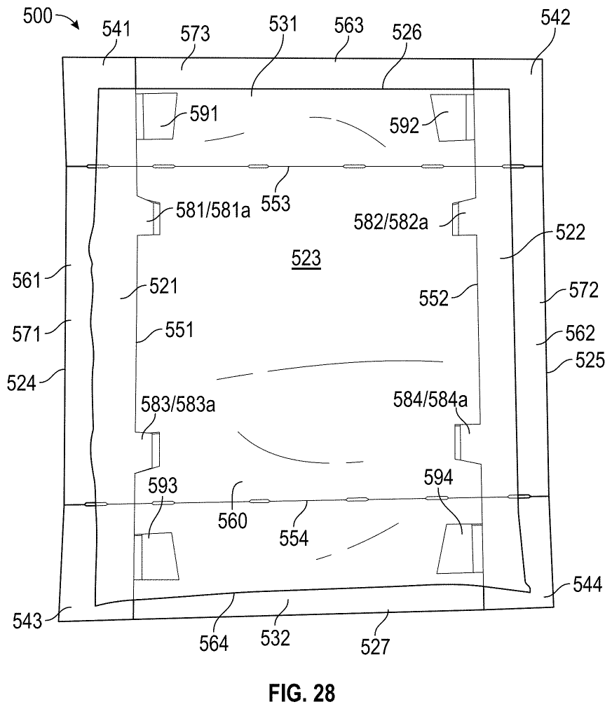

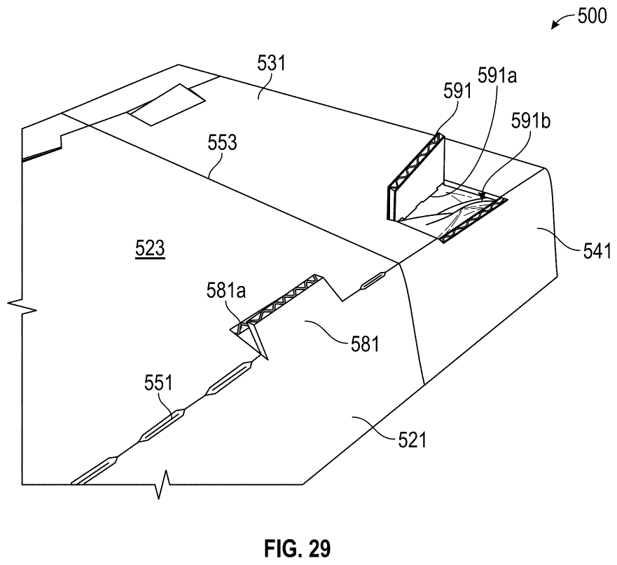

FIG. 27-33 illustrates a fourth packaging assembly 500. The packaging assembly 500 can include a frame 520. The frame 520 can be formed out of a corrugated cardboard sheet, wood pulp products, plastic or other materials. The frame 520 can be formed as a square or rectangular sheet having first and second lateral sides 526, 527 and first and second ends 524, 525. The frame 520 can include a first fold line 551. The first fold line 551 can be located on a first side of a platform 523. A second fold line 552 can be located on a second side of the platform 523. The first and second fold lines 551, 552 can be parallel. The first and second fold lines 551, 552 can extend from between outer lateral sides 526, 527 of the frame 520. The first and second fold lines 551, 552 can extend a width of the first end of the frame 520 and/or a width of the second end of the frame 520. The first fold line 551 can define a first wing portion 521. The first wing portion 521 can be pivotably connected with the platform 523 from the first fold line 551. A second wing portion 522 can be connected with the platform 523 by the second fold line 552. The second wing portion 522 can be pivotable relative to the platform about the second fold line 552.

The frame 520 can include a third fold line 553. The third fold line 553 can extend along a third side of the platform 523. The third fold line 553 can extend along a length of the frame 520 between first and second ends 524, 525 of the frame 520. The frame 520 can include a fourth fold line 554. The fourth fold line 554 can extend parallel to the third fold line 553. The fourth fold line 554 can extend along the length of the frame 520 between the first and second ends 524, 525 thereof. The third and fourth fold lines 553, 554 can be parallel. The third and fourth lines 553, 554 can be anti-parallel, transverse, or perpendicular to the second and first fold lines 551, 552. The third fold line 553 can bound a first lateral portion (or third wing) 531. The first lateral portion 531 can be separated from the platform 523 by the third fold line 553. The first lateral portion 531 can be pivotable with respect to the platform 523 about the third fold line 553. A second lateral portion (or fourth wing) 532 can be connected with the platform 523 about the fourth fold line 554. The second lateral portion 532 can be pivotable with respect to the platform 523 about the fold line 554. The first lateral portion 531 can extend along the first lateral side 526 of the frame 520. The second lateral portion 532 can extend along the second lateral side 527 of the frame 520.

The first fold line 551 and the third fold line 553 can also partially define a first corner portion 541. The first corner portion 541 can be located between the first wing portion 521 and the first lateral portion 531. The first corner portion 541 can be generally aligned with the first lateral portion 531 and a first wing portion 521. The first fold line 551 and the fourth fold line 554 can be bound or at least partially define a second corner portion 542. The second corner portion 542 can be aligned with the first wing portion 521 and the second lateral portion 532. The second fold line 552 and the third fold line 553 can form a third corner 543. The third corner 543 can be at least partially bounded by the second fold line 552 and the third fold line 553. The third corner 543 can be aligned with the first lateral portion 531 and the second wing portion 522. The second fold line 552 and the fourth fold line 554 can at least partially bound to define a fourth corner portion 544. The fourth corner portion 544 can be aligned with the second lateral portion 532 and the second wing portion 522. The corner portions 541-544 can be square or rectangular depending on the outer shape of the frame 520 which is generally square or rectangular, but this is not required.

The retention member 560 can be formed of a thin resilient film material such as a polymer. An exemplary material for the retention member 560 is low density polyethylene. Low density polyethylene is highly recyclable and can be heat sealed directly to an outer face of a corrugated cardboard member as described in U.S. application Ser. No. 54/222,410. Alternatively, the retention member 560 can be attached using mechanical means such as adhesive, pressure sensitive strips, staples, pockets, or the like. The retention member 560 can be generally formed as a square or rectangular member that generally corresponds to the size and shape of the frame 520. The retention member 560 can overlay the frame 520 including the central panel platform 523, first and/or second wing portions 521, 522, the first and/or second lateral portions 531, 532, and/or the first, second, third, and/or fourth corner portions 541, 542, 543, 544.

The retention member 560 can include a first end 561 and a second end 562. The first end 561 can be generally aligned with the first wing 521 of the frame 520. The first end 561 can be attached with the frame 520 on the corner 541, the first wing portion 521, and/or the second corner 542. The first end 561 can include an attachment portion 571. The attachment portion 571 can extend across the first corner 541, the first wing portion 521, and/or the second corner 542. The first end 561 can have a width. The width can be at least as great as a width of the first wing portion 521. Optionally the width can be equal to the width of the frame 520 on the first end 524. Alternatively, the attachment portion 571 can be located only on the first wing 521. In another alternative, the attachment portion 571 can comprise one or more discrete attachment points on the first wing 521, the first corner 541 or the second corner 542.

The first end 561 of the retention member 560 can extend from the first lateral side 526 to the second lateral side 527 of the frame 520. Optionally, the first end 561 can be aligned with the first end 524 of the frame 520. The first end 561 can also be offset from the first end 524. The second end 562 can be aligned with the second end 525 of the frame 520 or offset therefrom. The second end 562 can extend across the third corner portion 543, the second wing portion 522, and/or the fourth corner 544. The second end 562 can include an attachment portion 572. The attachment portion 572 can extend on the third corner portion 543, the second wing portion 522, and/or the fourth corner portion 544. The second end 562 can have a width. The width can be greater than a width of the second wing portion 522. The width can be as great as the width of the second end 525 frame 520. Alternatively, the attachment portion 572 can be located only on the second wing 522. In another alternative, the attachment portion 572 can comprise one or more discrete attachment points on the second wing 522, the third corner 543 or the fourth corner 544.

A third end 563 of the retention member 560 can extend from the first end 524 to the second 525 of the frame 520. The third end 563 can also be offset or aligned with the third side 526. The third end 563 can extend across the third corner portion 543, the first lateral portion 531, and/or the first corner 541. The third end 563 can include an attachment portion 573. The attachment portion 573 can extend on the third corner portion 543, the first lateral portion 531, and/or the first corner portion 541. The third end 563 can have a width. The width can be greater than a width of the second wing portion 522. Alternatively, the attachment portion 573 can be located only on the first lateral portion 531. In another alternative, the attachment portion 573 can comprise one or more discrete attachment points on the first lateral portion 531, the third corner 543 or the first corner 541.

The attachment portions 571-573 can include adhesives, staples, heat seals, or any other attachment mechanism between a resilient member and corrugated cardboard or other types of materials. Together the attachment portions 571-573 can enclose three sides of the frame 520 extending across the first wing portion 521, the first lateral portion 531 and the second wing portion 522 (and/or the corner portions 541-442). A central portion of the retention member 560 can overlay the platform 523 and/or other portions of the frame 520. The central portion is not attached with the frame 520 or otherwise overlays the frame 520 such that an article can be placed between the platform 523 and the central portion of the retention member 560.

A fourth side 564 of the retention sheet 560 can be aligned along the second lateral side 527. The fourth side 564 can be unattached with the frame 120. Alternatively, the fourth side 564 can include at least a portion that is unattached over the second lateral portion 532.

The unattached fourth side 564 can create an opening beneath the central portion of the retention sheet 560 to allow placement of an article on the central platform 523. To place the article, it may be necessary to fold the first wing portion 522 and the second wing portion 522 upwardly along the first and second fold lines 551, 552 to provide slack in the retention member 560.

The frame 520 can include a plurality of locking tabs configured to engage with locking flaps in the manner described below. The frame 520 can include locking tabs 581, 582, 583, 584. The locking tabs can be aligned along the first and second fold lines 551, 552. The first locking tab 581 can be formed by a cutout portion 581a from the central platform 523. The first locking tab 581 can be formed integrally with the first wing 521. The first locking tab 581 can be rectangular in shape. A base of the locking tab 581 can be aligned with the first fold line 551. Rotation of the first wing 521 about the fold line 551 can raise the locking tab 581 relative to the central platform 523 and/or out of the cutout portion 581a. The angle of the locking tab 581 relative to the central platform can be determined by the position of the first wing 521. The first tab 581 can be adjacent to the third fold line 553. The second tab 582 can be adjacent to the fourth fold line 554 and formed by a cutout region 582a and otherwise have the same structure as the first locking tab 581. The third locking tab 583 can be located along the second fold line 552 and be a part of the second wing portion 522 formed from a cutout portion 583a. The third locking tab 583 can otherwise have the same structure as the first locking tab 581. The fourth locking tab 584 can be located along the second fold line 552 and be a part of the second wing portion 522 formed from a cutout portion 584a. The fourth locking tab 584 can otherwise have the same structure as the second locking tab 582.

The frame 520 can include locking flaps 591, 592, 593, 594. The locking flaps can be aligned along the first and second fold lines 551, 552. The first locking flap 591 can be pivotable about a fold line 591a. The fold line 591a can be connected with the first lateral portion 531. The first locking flap 591 can be formed by a cutout portion 59 lb from the first lateral portion 531. The first locking flap 591 can be formed integrally with the first lateral portion 531 (connected by the fold line 591a). The first fold line 591a can be at an angle A relative to the third fold line 553. Angle A can be acute, normal, or obtuse. The first locking flap 591 can be polygonal in shape. Alternatively, the first locking flap 591 can be rectangular in shape. One end of the locking flap 591 can be aligned parallel with the first fold line 551. A slot can be disposed between the end of the locking flap 591 and the first corner 541. The slot can be rectangular. A width of the slot can correspond to a thickness of the locking tab 581. Rotation of the locking flap 591 about the fold line 591a can enlarge the slot.

The first flap 591 can be adjacent to the third fold line 553 and formed from the cutout portion 591b. The first flap 591 can be spaced away from the third fold line 553 the same distance that the first locking tab 581 is spaced away from the third fold line 553. The first lateral portion 531 can be folded along the third fold line 553 and the first locking tab 581 can be aligned with the first flap 591. The first locking tab 581 can be received within the slot of the cutout portion 591b.

The second flap 592 can include a fold line 592a and a cutout portion 592b from the first lateral portion 531 and be adjacent to the second fold line 552 and otherwise have the same structure as the first locking flap 591. The third locking flap 593 can include a fold line 593a and a cutout portion 593b from the second lateral portion 532 and be adjacent to the first fold line 551 and otherwise have the same structure as the first locking flap 591. The fourth flap 594 can include a fold line 594a and a cutout portion 594b from the second lateral portion 532 and be adjacent to the second fold line 552 and otherwise have the same structure as the first locking flap 591.

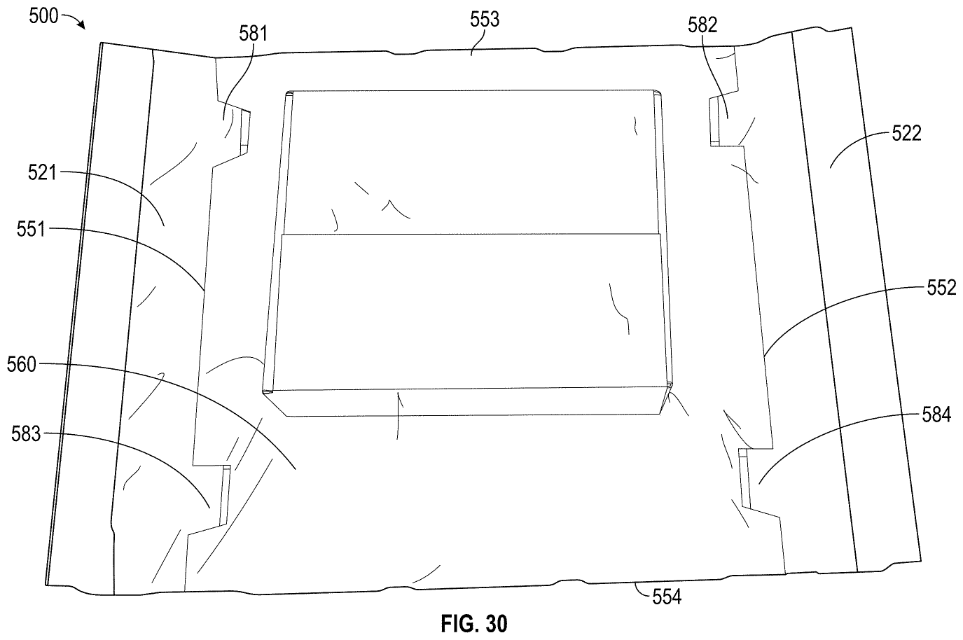

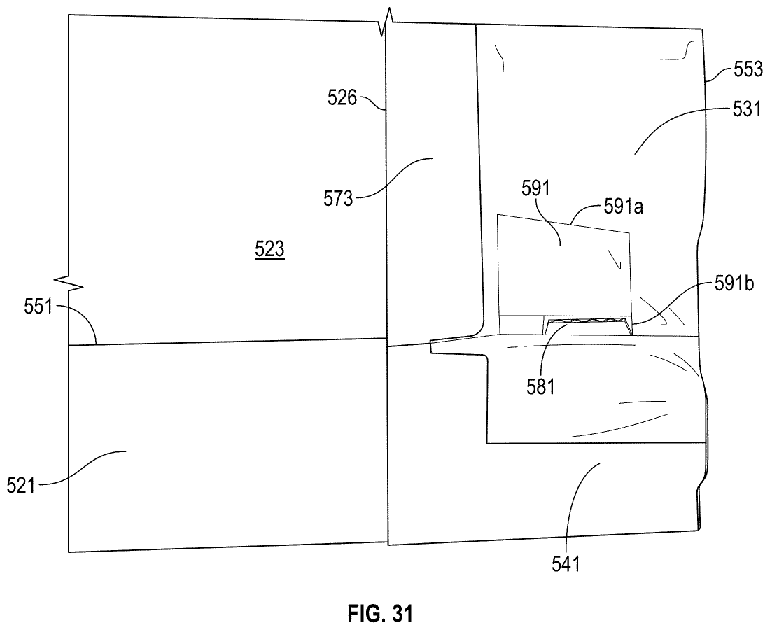

As shown in FIGS. 30-31, to close the assembly, the first lateral portion 531 can be folded downwardly along the third fold line 553 and the second lateral portion 532 can be folded downwardly along the fourth fold line 554. The first corner and the third corners 541, 543 can be folded along with the first lateral portion 531. The second corner and the fourth corners 542, 544 can be folded along with the second lateral portion 532. Folding the second lateral portion 532 can close the opening defined by the fourth edge 564. In certain implementations, an adhesive strip can be attached with the second lateral portion 532 to attach with the lateral edge 564. In another implementation, at least one tab can be included on the second lateral portion 532 to engage with the lateral edge 564

The first lateral portion 531 can be folded against an underside of the platform 523. Likewise, the first corner 541 can be folded against the underside of the first wing portion 521 and the third corner portion 543 can be folded against an underside of the second wing portion 522. The locking flaps 591, 593 can be aligned with the corresponding locking tabs 581, 583. Similarly, the second lateral portion 532 can be folded against an underside of the platform 523. Likewise, the second corner 542 can be folded against the underside of the first wing portion 521 and the fourth corner portion 544 can be folded against an underside of the second wing portion 522. The locking flaps 592, 594 can be aligned with the corresponding locking tabs 582, 584. The locking tabs can initially be above the locking flaps (e.g., not within the slots).

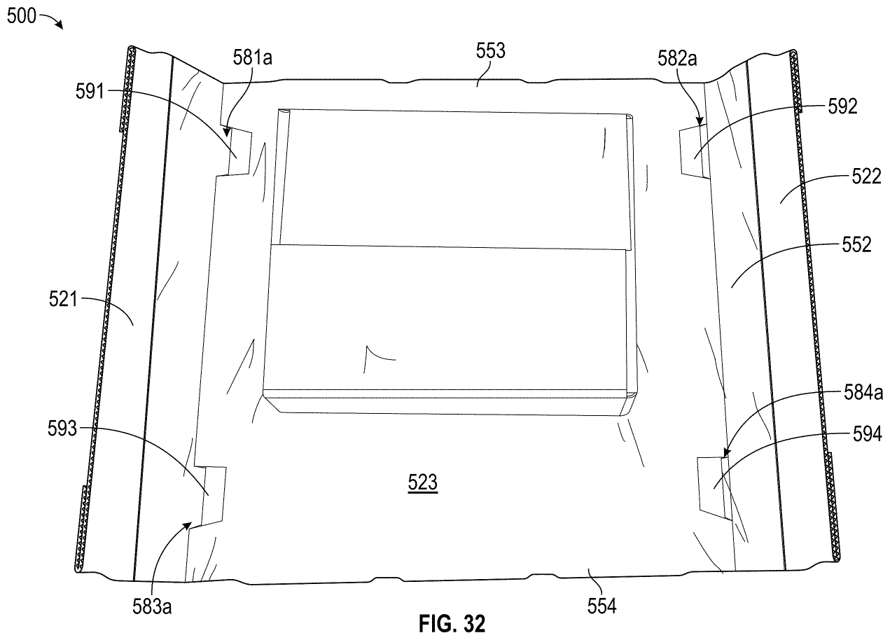

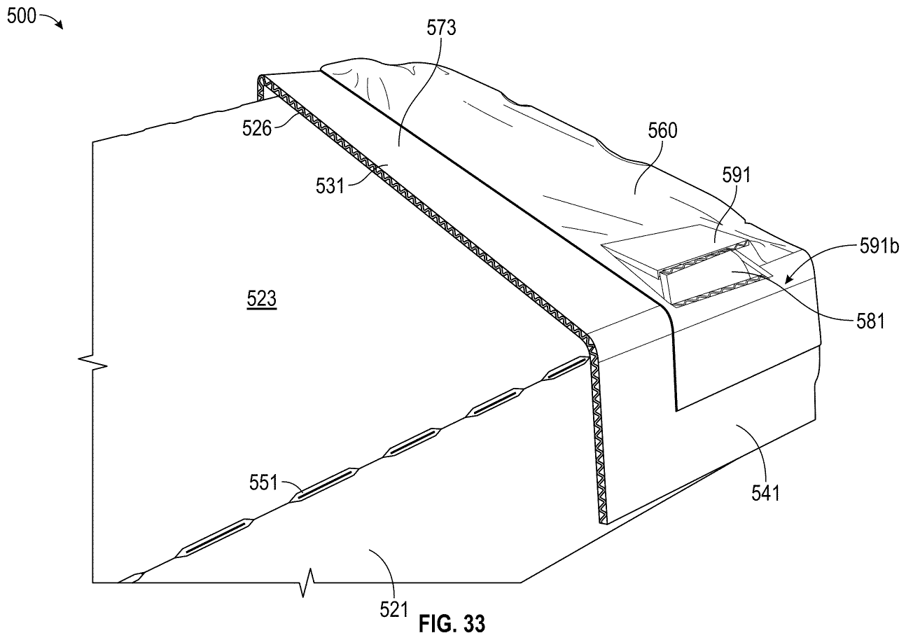

As shown in FIGS. 32-33, the first wing portion 521 can be folded along the first fold line 551. The locking tabs 581, 582 can be rotated relative to the locking flaps 591, 592 with the first wing portion 521. The rotation of the first wing portion can engage the locking tabs 581, 582 within the slots formed by the locking flaps 591, 592, respectively. This may include deflection of the locking flaps 591, 592 outwardly along the respective fold lines 591a, 592a. The second wing portion 522 can be folded along the second fold line 552. The locking tabs 583, 584 can be rotated relative to the locking flaps 593, 594 with the second wing portion 522. The rotation of the wing portion can engage the locking tabs 583, 584 within the slots formed by the locking flaps 593, 594, respectively. This may include deflection of the locking flaps 593, 594 outwardly along the respective fold lines 593a, 594a. The locking tabs can snap into the slots and be located beneath the locking flaps. The locking engagement between the locking tabs and locking flaps can lock the positions of the lateral portion 531, 532 that tension the sheet 560. This arrangement can also maintain a relative (upright) angle between the wing portions 521, 522 and the central platform 523.

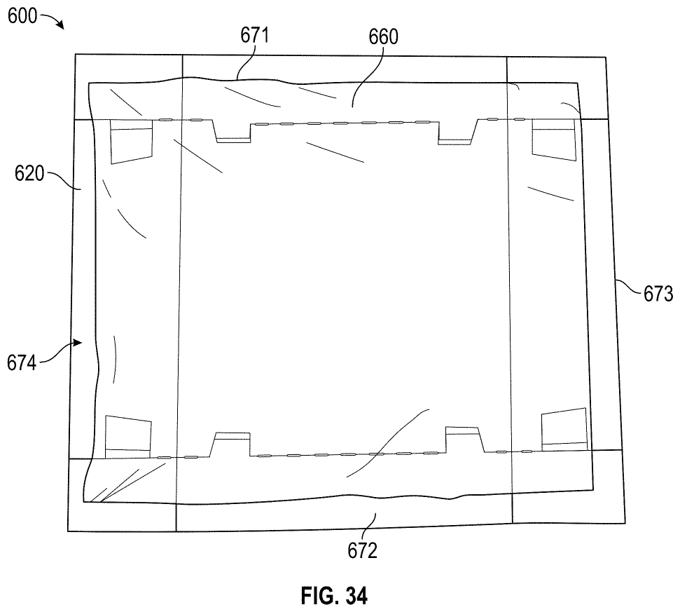

FIG. 34 shows a fifth packaging assembly 600. The packaging assembly 600 can have the same structure as the packaging assembly 500. A retention sheet 660 can be attached with a frame 620. The retention sheet 660 can be attached along first, second, and third sides 671, 672, 673. A fourth side 674 can be open. An exemplary material for the retention member 660 is a compostable and/or biodegradable film. The film can comprise Aliphatic polymer. The film can specifically comprise a Aliphatic-Aromatic Polyester Blend. The sheet 660 can be heat sealed directly to an outer face of a corrugated cardboard member as described in U.S. application Ser. No. 54/222,410. Alternatively, the retention sheet 660 can be attached using mechanical means such as adhesive, staples, pressure-sensitive strips, pockets, or the like. The retention sheet 660 can be generally formed as a square or rectangular member that generally corresponds to the size and shape of the frame.

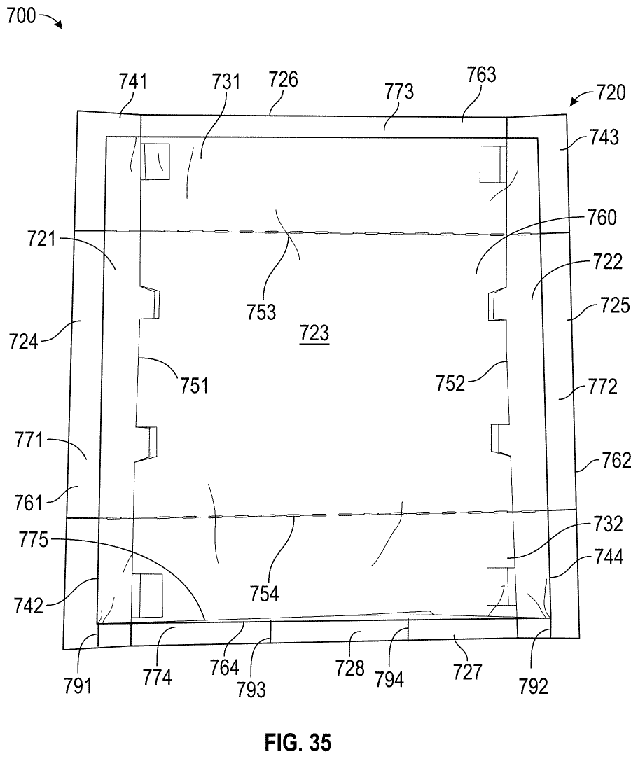

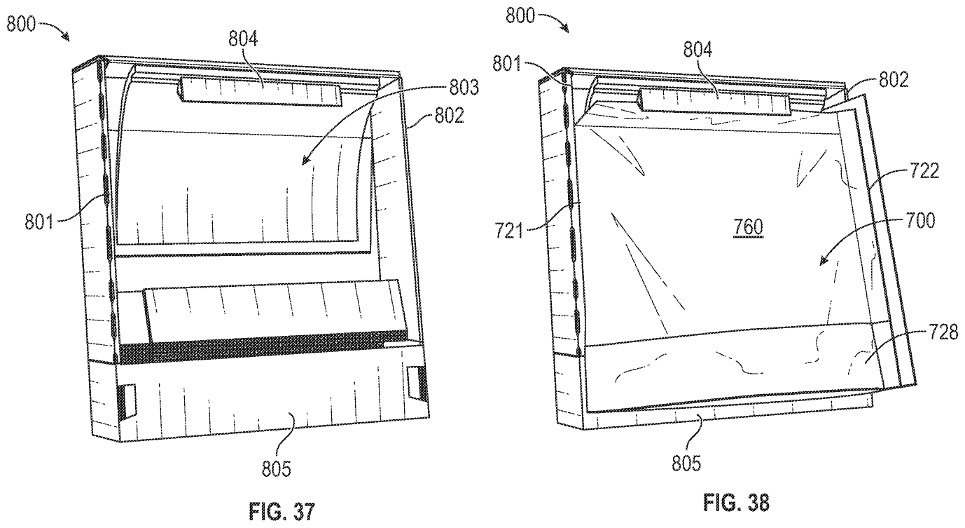

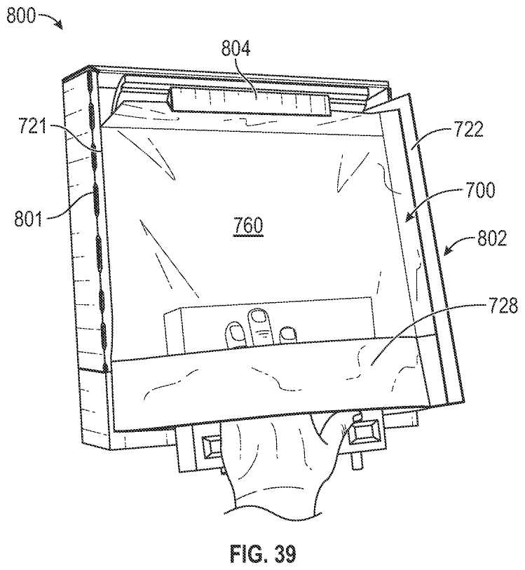

FIGS. 35-39 illustrate a sixth packaging assembly 700 and jig 800. The packaging assembly 700 can have the same structure as the packaging assembly 500 with any differences noted below. The packaging assembly 700 can include a frame 720. The frame 720 can include a first wing portion 721. The frame 720 can include a first fold line 751 with a central platform 723. The first fold line 751 can define the first wing portion 721. The frame 720 can include a first end 724. The frame 720 can include a second wing portion 722. The frame 720 can include a second fold line 752 with the central platform 723. The second fold line 752 can define the second wing portion 722. The frame 720 can include a second end 724. The frame 720 can include a first lateral portion 731. The frame 720 can include a third fold line 753 with the central platform 723. The third fold line 753 can define the first lateral portion 731. The frame 720 can include a third end 726. The frame 720 can include a second lateral portion 732. The frame 720 can include a fourth fold line 754 with the central platform 723. The fourth fold line 754 can define the second lateral portion 732. The frame 720 can include a fourth end 727.

The frame 720 can include a first corner 741. The first corner 741 can be defined by the first and third fold lines 751, 753. The frame 720 can include a second corner 742. The second corner 742 can be defined by the first and fourth fold lines 751, 754. The frame 720 can include a third corner 743. The third corner 743 can be defined by the second and third fold lines 752, 753. The frame 720 can include a fourth corner 744. The fourth corner 744 can be defined by the second and fourth fold lines 752, 754. The frame 720 can include locking tabs (like tabs 581-584). The frame 720 can include locking flaps (like flaps 591-594).

The second lateral portion 732 (and/or the third or fourth corner portions 743, 744) can include an outer strip or bridge 728. The bridge 728 can be defined by a cut 775. The cut 775 can be parallel with the fourth fold line 754. The cut 775 can be located outwardly (e.g. below) the locking flaps of the second lateral portion 732. The bridge 728 can extend from the first wing 721 to the second wing 722. The bridge 728 can include a first fold line 791. The first fold line 791 can be offset from the first fold line 751. The bridge 728 can include a second fold line 792. The second fold line 792 can be offset from the second fold line 752. The bridge 728 can additional include one or more fold line 793, 794. The fold lines can facilitate the bridge 728 lifting up (away from the remainder of the second lateral portion 732) when the first and second wings 721, 722 are folded along the fold line 751, 752.

A retention sheet 760 can be attached with the frame 720. The retention sheet 760 can extend over the central platform 723. A first end 761 can be attached with the first wing portion 721 at a first attachment portion 771. A second end 762 can be attached with the second wing portion 722 at a second attachment portion 772. A third end 763 can be attached with the first lateral portion 731 at a first attachment portion 773. A fourth end 764 can be attached with the bridge 728 at a fourth attachment portion 774. The retention sheet 760 can extend over the cut 775. The attachment portions 771-774 can fully or partially enclose the outer edges of the retention sheet 760. The first attachment portion 771 can extend continuously from the third end 726 to the fourth end 727. The second attachment portion 772 can extend continuously from the third end 726 to the fourth end 727. The third attachment portion 773 can extend continuously from the first end 724 to the second end 725. The fourth attachment portion 774 can extend continuously from the first end 724 to the second end 725. The first attachment portion 771 can merge with the third attachment portion 773 and the fourth attachment portion 774 on the respective corners 741, 742. The second attachment portion 772 can merge with the third attachment portion 773 and the fourth attachment portion 774 on the respective corners 743, 744.

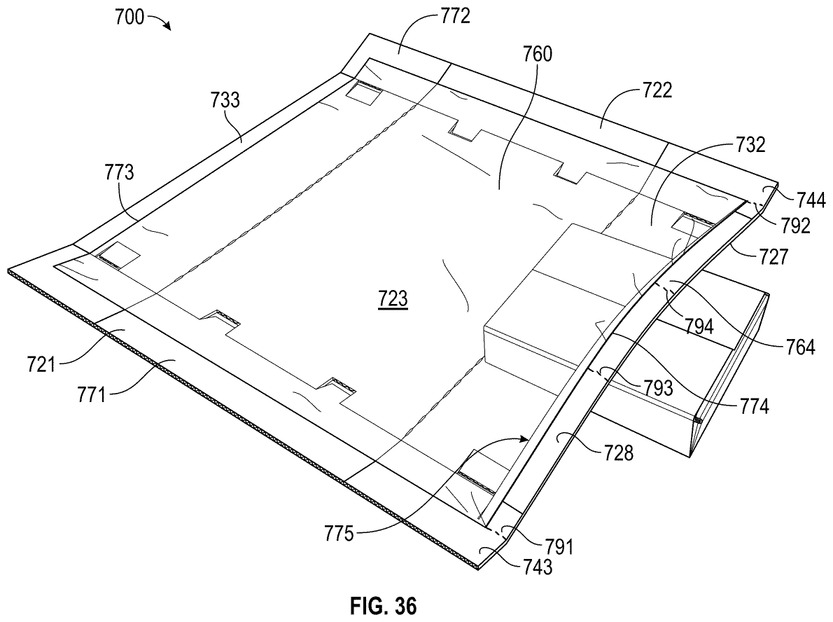

The central platform 723 can be accessible (underneath the sheet 760) through the cut. The bridge 728 can be raised to lift the sheet 760 away from the central platform and to enlarge an opening of the assembly, as shown in FIG. 36. The assembly can then be securely closed by folding the second lateral portion 7f32 under the central portion 723. The locking tabs can be engaged with the locking flaps as described above in regards to packaging assembly 500.

A jig 800 can be used to aid in loading the frame 700. The jig can include a first wall 801 spaced from a second wall 802. The walls 801, 802 can be spaced apart to receive the frame 720. The frame 720 can be received in a folded configuration. The walls 801, 802 can be spaced apart to receive the platform 723 and to fold the first and second wing 721, 722. The folding of the first and second wing 721, 722 can lift the bridge 728. Lifting the bridge 728 can provide access to the platform 723 beneath the retention sheet 760. The bridge 7 can be lifted out of alignment with the platform 723 by the interaction of the wings 721, 722 with the fold lines 791, 792.

A brace 804 can be located between the first and second wall 801, 802. The brace can locate the third end 726 of the frame 720 and position the fourth end 727 and bridge 728 on a support 805. The support 805 can angle the fourth end 727 upwardly so as to facilitate loading of an article into the frame 720. After the frame 720 is loaded, the second lateral portion 732 (and bridge 728) can be rotated downwardly, such as beneath the platform 723. This can close the opening into the platform 723. The closing of the opening can secure the loaded articles in place and/or stretch the retention sheet 760 to inhibit movement of the articles during storage or shipping.

The various features and advantages of the systems, devices, and methods of the technology described herein will become more fully apparent from the following description of the examples illustrated in the figures. These examples are intended to illustrate the principles of this disclosure, and this disclosure should not be limited to merely the illustrated examples. The features of the illustrated examples can be modified, combined, removed, and/or substituted as will be apparent to those of ordinary skill in the art upon

### Certain Terminology

Terms of orientation used herein, such as “top,” “bottom,” “proximal,” “distal,” “longitudinal,” “lateral,” and “end,” are used in the context of the illustrated example. However, the present disclosure should not be limited to the illustrated orientation. Indeed, other orientations are possible and are within the scope of this disclosure. Terms relating to circular shapes as used herein, such as diameter or radius, should be understood not to require perfect circular structures, but rather should be applied to any suitable structure with a cross-sectional region that can be measured from side-to-side. Terms relating to shapes generally, such as “circular,” “cylindrical,” “semi-circular,” or “semi-cylindrical” or any related or similar terms, are not required to conform strictly to the mathematical definitions of circles or cylinders or other structures, but can encompass structures that are reasonably close approximations.

Conditional language, such as “can,” “could,” “might,” or “may,” unless specifically stated otherwise, or otherwise understood within the context as used, is generally intended to convey that certain examples include or do not include, certain features, elements, and/or steps. Thus, such conditional language is not generally intended to imply that features, elements, and/or steps are in any way required for one or more examples.

Conjunctive language, such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain examples require the presence of at least one of X, at least one of Y, and at least one of Z.

The terms “approximately,” “about,” and “substantially” as used herein represent an amount close to the stated amount that still performs a desired function or achieves a desired result. For example, in some examples, as the context may dictate, the terms “approximately,” “about,” and “substantially,” may refer to an amount that is within less than or equal to 10% of the stated amount. The term “generally” as used herein represents a value, amount, or characteristic that predominantly includes or tends toward a particular value, amount, or characteristic. As an example, in certain examples, as the context may dictate, the term “generally parallel” can refer to something that departs from exactly parallel by less than or equal to 20 degrees. All ranges are inclusive of endpoints.

### Summary

Several illustrative examples of packaging systems have been disclosed. Although this disclosure has been described in terms of certain illustrative examples and uses, other examples and other uses, including examples and uses which do not provide all of the features and advantages set forth herein, are also within the scope of this disclosure.

Components, elements, features, acts, or steps can be arranged or performed differently than described and components, elements, features, acts, or steps can be combined, merged, added, or left out in various examples. All possible combinations and subcombinations of elements and components described herein are intended to be included in this disclosure. No single feature or group of features is necessary or indispensable.

Certain features that are described in this disclosure in the context of separate implementations can also be implemented in combination in a single implementation. Conversely, various features that are described in the context of a single implementation also can be implemented in multiple implementations separately or in any suitable subcombination. Moreover, although features may be described above as acting in certain combinations, one or more features from a claimed combination can in some cases be excised from the combination, and the combination may be claimed as a subcombination or variation of a subcombination.

Any portion of any of the steps, processes, structures, and/or devices disclosed or illustrated in one example in this disclosure can be combined or used with (or instead of) any other portion of any of the steps, processes, structures, and/or devices disclosed or illustrated in a different example or flowchart. The examples described herein are not intended to be discrete and separate from each other. Combinations, variations, and some implementations of the disclosed features are within the scope of this disclosure.

While operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Additionally, the operations may be rearranged or reordered in some implementations. Also, the separation of various components in the implementations described above should not be understood as requiring such separation in all implementations, and it should be understood that the described components and systems can generally be integrated together in a single product or packaged into multiple products. Additionally, some implementations are within the scope of this disclosure.

Further, while illustrative examples have been described, any examples having equivalent elements, modifications, omissions, and/or combinations are also within the scope of this disclosure. Moreover, although certain aspects, advantages, and novel features are described herein, not necessarily all such advantages may be achieved in accordance with any particular example. For example, some examples within the scope of this disclosure achieve one advantage, or a group of advantages, as taught herein without necessarily achieving other advantages taught or suggested herein. Further, some examples may achieve different advantages than those taught or suggested herein.

Some examples have been described in connection with the accompanying drawings. The figures are drawn and/or shown to scale, but such scale should not be limiting, since dimensions and proportions other than what are shown are contemplated and are within the scope of the disclosed invention. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various examples can be used in all other examples set forth herein. Additionally, any methods described herein may be practiced using any device suitable for performing the recited steps.

For purposes of summarizing the disclosure, certain aspects, advantages and features of the inventions have been described herein. Not all, or any such advantages are necessarily achieved in accordance with any particular example of the inventions disclosed herein. No aspects of this disclosure are essential or indispensable. In many examples, the devices, systems, and methods may be configured differently than illustrated in the figures or description herein. For example, various functionalities provided by the illustrated modules can be combined, rearranged, added, or deleted. In some implementations, additional or different processors or modules may perform some or all of the functionalities described with reference to the examples described and illustrated in the figures. Many implementation variations are possible. Any of the features, structures, steps, or processes disclosed in this specification can be included in any example.

In summary, various examples of packaging systems and related methods have been disclosed. This disclosure extends beyond the specifically disclosed examples to other alternative examples and/or other uses of the examples, as well as to certain modifications and equivalents thereof. Moreover, this disclosure expressly contemplates that various features and aspects of the disclosed examples can be combined with, or substituted for, one another. Accordingly, the scope of this disclosure should not be limited by the particular disclosed examples described above, but should be determined only by a fair reading of the claims.

1-33. (canceled)

34. A packaging assembly comprising:
a frame formed of a cardboard sheet, including:
a platform;
a first wing connected with the platform at a first fold line;
a second wing connected with the platform at a second fold line;
a third wing connected with the platform at a third fold line;
a first locking tab on the third wing;
wherein the frame is configured to be transitioned from a flat configuration to a locked configuration by rotating the first wing on the first fold line to an underside of the platform, rotating the second wing on the second fold line to an underside of the platform, and rotating the third wing to engage the first locking tab with the first wing to retain a rotated position of the first wing.

35. The packaging assembly of claim 34, further comprising a retention member including:
a first end attached with the first wing;
a second end attached with the second wing; and
a third end overlapping the third wing as an opening on a side of the platform;
wherein rotating the third wing encloses the open side of the platform.

36. The packaging assembly of claim 34, wherein the first locking tab of the first wing is formed from a first cutout portion of the platform, the first locking tab extending from the first fold line.

37. The packaging assembly of claim 34, wherein rotating the third wing engages the first locking tab with both the first wing and the second wing to retain the rotated positions of the first wing and the second wing.

38. The packaging assembly of claim 37, wherein:
the frame further comprises a fourth wing connected with the platform at a fourth fold line and a second locking tab on the fourth wing;
wherein rotating the fourth wing engages the second locking tab with both the first wing and the second wing, on as opposite side as the first locking tab, to retain the rotated positions of the first wing and the second wing.

39. The packaging assembly of claim 38, further comprising a retention member including:
a first end attached with the first wing;
a second end attached with the second wing;
a third end attached with the third wing; and
a fourth end of the retention member forming an opening beneath the retention member to the platform.
wherein the opening is configured to be closed by folding a fourth wing of the frame connected with the platform at a fourth fold line.

40. The packaging assembly of claim 34, further comprising a second locking tab on the third wing, wherein rotating the third wing engages the first locking tab with the first wing and engages the second locking tab with the second wing to retain the rotated positions of the first wing and the second wing.

41. The packaging assembly of claim 40, wherein:
the frame further comprises a fourth wing connected with the platform at a fourth fold line and third and fourth locking tabs on the fourth wing;
wherein rotating the fourth wing engages the third locking tab with the first wing and engages the fourth locking tab with the second wing, on as opposite side as the first and second locking tabs, to retain the rotated positions of the first wing and the second wing.

42. The packaging assembly of claim 40, wherein the first wing includes a first locking slot, the first locking slot configured to aligned with the first locking tab when the first wing is folded along the first fold line under the platform.

43. The packaging assembly of claim 42, wherein the first locking slot is formed within the first wing at an equal distance from the first fold line as the first locking tab.

44. The packaging assembly of claim 42, wherein the first locking slot is formed by a first locking flap formed by a first cutout portion from the first wing.

45. The packaging assembly of claim 44, wherein the first locking flap includes a first flap fold line.

46. The packaging assembly of claim 44, wherein the first locking tab is configured to be received beneath the first locking flap and within the first locking slot by rotation of the third wing.

47. The packaging assembly of claim 46, wherein engagement of the first locking flap with the first locking tab maintains the third wing in a raised position relative to the platform.

48. The packaging assembly of claim 34, wherein the retention member comprises a aliphatic-aromatic polyester blend.

49. The packaging assembly of claim 34, further comprising a retention member including:
a first end attached with the first wing;
a second end attached with the second wing; and
a third end attached with the third wing;

50. The packaging assembly of claim 49, further comprising a fourth end of the retention member forming an opening, the opening configured to be closed by folding a fourth wing of the frame connected with the platform at a fourth fold line.

51. The packaging assembly of claim 49, further comprising a fourth end of the retention member connected with an outer strip of a fourth wing of the frame connected with the platform at a fourth fold line, the outer strip forming an opening, the opening configured to be closed by folding the fourth wing of the frame connected at the fourth fold.

52. The packaging assembly of claim 51, wherein the outer strip separated from a remainder of the fourth wing by a cut, the cut being parallel with the fourth fold line.
